(19) United States
(12) Patent Application Publication
(10) Pub. No.: US 2016/0280939 A1
(43) Pub. Date: Sep. 29, 2016

(54) Drying Agents, Compositions Having Drying Agents and Methods for Making and Using the Same

(71) Applicant: Dura Chemicals, Inc., Emeryville, CA (US)

(72) Inventors: Dennis J. Olszanski, Sanford, FL (US); Larry A. Filachek, Manalapan, NJ (US); Edward J. Doenges, Iselin, NJ (US); Stefan Bankov, Highland Park, NJ (US)

(21) Appl. No.: 15/077,293

(22) Filed: Mar. 22, 2016

Related U.S. Application Data
(60) Provisional application No. 62/137,694, filed on Mar. 24, 2015.

(51) Int. Cl. C09D 7/12; C09D 167/08; C09D 175/04

(52) U.S. Cl. CPC C09D 7/1233; C09D 175/04; C09D 167/08

(57) ABSTRACT

Aspects of the disclosure include a drying agent that includes a metal organic salt of an α-hydroxy acid for use as a drier in liquid (e.g., coatings, inks, lubes, greases) compositions. Compositions having a waterborne or oil-based composition and a drying agent are also described. Also provided are methods of producing a coating on a surface, by applying to the surface a composition having a drying agent that includes a metal organic salt of an α-hydroxy acid. Methods for preparing an air-drying composition by combining a waterborne or oil-based composition and a drying agent having a metal organic salt of an α-hydroxy acid are also described.

### CROSS-REFERENCE TO RELATED APPLICATION

Pursuant to 35 U.S.C. §119(e)(1), this application claims priority to U.S. Provisional Application No. 62/137,694, filed Mar. 24, 2015, the disclosure of which is incorporated herein by reference.

### INTRODUCTION

Drying agents and compositions which aid air drying liquid compositions are used in a variety of compositions, such as paints, coatings, inks, resins, lubricants and greases. Drying agents can be used as part of a binder to accelerate the hardening of drying compositions in paints, coatings, inks, resins, lubricants and greases through chemical crosslinking of the drying composition to produce an organic plastic layer.

Commercial drying agents are often compounds that are soluble only in non-polar solvents making them suitable only for use in oil-based paints and resins. Oil-based paints and resins account for approximately 15 percent of coating compositions sales in United States. The popularity of oil based paints is attributed to their durability in under harsh, outdoor weather conditions. Environmental concerns have arisen recently about oil-based paints and resins because of volatile organic compounds (VOCs), water polluting solvent bases and other environmentally detrimental components, in particular due to overly prevalent disposal down residential drains, storm drains and in landfill designated trash. To help to alleviate the impact of paints and resins containing volatile organic compounds on the environment, the use of water as a solvent replacement for harsh petroleum-based organic solvents is desirable.

### SUMMARY

Aspects of the disclosure include a drying agent that includes a metal organic salt of an α-hydroxy acid for use as a drier in liquid (e.g., coatings, inks, lubes, greases) compositions. Compositions having a waterborne or oil-based composition and a drying agent are also described. Also provided are methods of producing a coating on a surface by applying to the surface a composition having a drying agent that includes a metal organic salt of an α-hydroxy acid. Methods for preparing an air-drying composition by combining a waterborne or oil-based composition and a drying agent having a metal organic salt of an α-hydroxy acid are also provided.

In embodiments, drying agents that include a metal organic salt of an α-hydroxy acid for use as a drier in liquid (e.g., coatings, inks, lubes, greases) compositions are provided. Metal organic salts of interest include salts of a variety of different metals, such as cobalt (Co), manganese (Mn), vanadium (V), iron (Fe), copper (Cu), (titanium (Ti)), cerium (Ce), zirconium (Zr), neodymium (Nd), calcium (Ca), strontium (Sr), zinc (Zn) and other metals used for the curing of coatings films and combinations thereof. In some instances, the metal salt may be a salt of a transition metal. For example, the transition metal may be Co(II), Co(III), Cu (II), Cu (III), V(II), V(III), Fe(II), Fe(III), Mn(II), Mn(III), Mn(IV), Ce(II), Ce(III), Ce(IV), Zr (IV), Nd (III), Sr (II), Zn (II) or a combination thereof. In some instances, the metal is cobalt, manganese, calcium or zirconium. In certain embodiments, α-hydroxy acids of interest include glycolic acid, lactic acid, tartaric acid, citric acid, malic acid, mandelic acid or a combination thereof. In certain embodiments, drying agents of interest include a cobalt salt of an α-hydroxy acid. In other embodiments, drying agents of interest include a manganese salt of α-hydroxy acid. For example, drying agents of interest may include, but are not limited to a cobalt salt of glycolic acid, a cobalt salt of lactic acid, a manganese salt of glycolic acid and a manganese salt of lactic acid. In embodiments, the subject drying agents are capable of being stably incorporated into a waterborne system (e.g., waterborne alkyd resin, waterborne urethane resin, such as a waterborne oil-modified urethane resin, etc.) in the absence of a surfactant and capable of being stably incorporated into an oil based system (e.g., oil-based alkyd resin, non-polar solventborne oil-modified urethane resin, etc.) where desired.

Compositions which include a waterborne composition (e.g., waterborne alkyd resin, waterborne urethane resin, such as a waterborne oil-modified urethane resin, etc.) or an oil-based composition (e.g., oil-based alkyd resin, oil-based urethane resin, etc.) and a drying agent having a metal organic salt of an α-hydroxy acid are also provided. In certain embodiments, compositions include a waterborne alkyd resin and one or more of the subject drying agents. Drying agents of interest are capable of being stably incorporated into the waterborne alkyd resin in the absence of a surfactant. In some embodiments, the waterborne alkyd resin includes a waterborne crosslinkable polymer precursor. For example, the waterborne crosslinkable polymer precursor may include an unsaturated polyester prepared from a polyol, a polycarboxylic acid or polycarboxylic anhydride and an unsaturated fatty acid.

The polyol may include two or more hydroxyl groups, such as three or more, such as four or more and including five or more hydroxyl groups. For example, the polyol may be a polyhydric alcohols such as glycerol, propylene glycol, neopentyl glycol, diethylene glycol, pentaerythritol, dipentaerythritol, ethylene glycol, trimethylolpropane, trimethylol ethane, di-trimethylol propane, 1,6-hexane diol and combinations thereof. In some embodiments, the polyol is glycerol. In certain instances, the polyol is propylene glycol.

The polycarboxylic acid may include two or more carboxylic acid groups, such as three or more, such as four or more and including five or more carboxylic acid groups. The polycarboxylic acid may include aromatic, aliphatic and cycloaliphatic polycarboxylic acids, as well as the corresponding anhydrides. For example, the polycarboxylic acid may be a polyacid such as maleic acid, fumaric acid, adipic acid, azelaic acid, phthalic acid and its regio-isomeric analogues, trimellitic acid, pyromellitic acid, pimelic acid, sebacic acid and tetra-hydrophthalic acid and combinations thereof. In other embodiments, the waterborne crosslinkable polymer precursor includes a polycarboxylic anhydride, such as maleic anhydride fumaric anhydride, adipic anhydride, azelaic anhydride, phthalic anhydride and its regio-isomeric analogues, trimellitic anhydride, pyromellitic anhydride, pimelic anhydride, sebacic anhydride and tetra-hydrophthalic anhydride.

Unsaturated fatty acids of interest may include conjugated or non-conjugated fatty acids derived from natural or synthetic oils, such as C₂-C₂₄ carboxylic acids, including linoleic acid, linolenic acid, oleic acid, ricinoleic acid, licanic acid and eleostearic acids and combinations thereof.

Compositions of interest may include a drying agent in an amount ranging from 0.001% to 5% w/w. In embodiments, the waterborne composition (e.g., waterborne alkyd resin) or oil-based composition (e.g., oil-based urethane) is present in the composition in an amount from 25% to 50% w/w. The weight ratio of the waterborne composition (e.g., waterborne alkyd resin) or oil-based composition (oil-based urethane) to drying agent varies and is, in certain instances, 25:1 or greater, such as 35:1 or greater and including 50:1 or greater. Where compositions of interest are waterborne, water may be present in an amount of 35% w/w water or greater, such as 50% w/w water or greater and in certain embodiments is 75% w/w water or greater.

Compositions described herein may, according to some embodiments, be formulated as an ink, resin, coating, thermoset resin, wood stain, floor sealant or paint. In these embodiments, compositions of interest may further include additional excipients, such as colorants, one or more pigments, anti-corrosives, extenders, stabilizers, dye, surfactants, emulsifiers, anti-oxidants, plasticizers, surface-controlling agents, anti-silking agents, defoaming agents, rheological controlling agents, active metal carbonates, nitrogen-containing ligands, binders, fillers, anti-reflective agents, diluents, and toughening agents as well as ultraviolet absorbers.

Aspects of the disclosure also include methods for forming a coating on the surface of a support. Methods according to certain embodiments include applying to the surface of the support a composition having a waterborne composition (e.g., waterborne alkyd resin) or an oil-based composition (e.g., oil-based urethane) and a drying agent that includes a metal organic salt of an α-hydroxy acid. The composition may be applied by any convenient protocol, e.g., spraying or brushing the composition onto the support surface. In embodiments, the composition is dried, such as by air drying, applying heat or a combination of air drying and applying heat to the applied composition. In some instances, the composition forms a coating on the support in 24 hours or less, where the coating may have a thickness of 50 μm or less.

Aspects of the disclosure also include methods for preparing the subject compositions. Methods according to certain embodiments include combining a waterborne composition (e.g., waterborne alkyd resin, waterborne urethane resin, such as a waterborne oil-modified urethane resin, etc.) or an oil-based composition (e.g., oil-based alkyd resin, oil-based urethane resin, etc.) and a drying agent where the drying agent includes a metal organic salt of an α-hydroxy acid. The drying agent may, in some instances, be incorporated into the composition in an amount ranging from 0.001% w/w to 5% w/w. In these embodiments, preparing air-drying compositions may include combining the resin with drying agent in a weight ratio of 25:1 or greater, such as 35:1 or greater and including 50:1 or greater. Where desired, the subject compositions may be formulated as an ink, resin, coating, thermoset resin, wood stain, floor sealant or paint. In these embodiments, the methods may further include combining a waterborne or oil-based composition, a drying agent and one or more excipients, such as a colorant, pigment, anti-corrosive, extender, stabilizer, dye, surfactant, emulsifier, anti-oxidant, siccative, plasticizer, surface-controlling agent, anti-silking agent, defoaming agent, rheological controlling agent, active metal carbonate, nitrogen-containing ligand, binder, filler, anti-reflective agent, diluent, and toughening agent or ultraviolet absorber.

### DEFINITIONS OF SELECT CHEMICAL TERMINOLOGY

The nomenclature of certain compounds or substituents are used in their conventional sense, such as described in chemistry literature including but not limited to Loudon, Organic Chemistry, Fourth Edition, New York: Oxford University Press, 2002, pp. 360-361, 1084-1085; Smith and March, March's Advanced Organic Chemistry: Reactions, Mechanisms, and Structure, Fifth Edition, Wiley-Interscience, 2001.

The term “alkyl” as used herein refers to a branched, unbranched or cyclic saturated hydrocarbon group of 1 to about 50 carbon atoms, such as methyl, ethyl, n-propyl, isopropyl, n-butyl, isobutyl, t-butyl, octyl, decyl, tetradecyl, hexadecyl, eicosyl, tetracosyl and the like. Preferred alkyl groups herein may contain 1 to about 36, more typically 1 to 10, carbon atoms. The term “lower alkyl” intends an alkyl group of 1 to 6 carbon atoms, preferably 1 to 4 carbon atoms. The alkyl groups present on the polymers described herein may be unsubstituted or they may be substituted with one or more substituents including functional groups (e.g., amine, hydroxyl, an olefinic group such as a vinyl or an allyl group), or the like. “Substituted alkyl” refers to alkyl substituted with one or more substituent groups, and this includes instances wherein two hydrogen atoms from the same carbon atom in an alkyl substituent are replaced, such as in a carbonyl group (i.e., a substituted alkyl group may include a —C(═O)— moiety). Other substituents include halogen, ether, hydroxyl, amine functional groups, etc. as defined in more detail below. The terms “heteroatom-containing alkyl” and “heteroalkyl” refer to an alkyl substituent in which at least one carbon atom is replaced with a heteroatom, such as O, S, P, or N, as described in further detail infra. If not otherwise indicated, the terms “alkyl” and “lower alkyl” include linear, branched, cyclic, unsubstituted, substituted, and/or heteroatom-containing alkyl or lower alkyl, respectively.

The term “alkylene” as used herein refers to a difunctional saturated branched or unbranched hydrocarbon chain containing from 1 to 50 carbon atoms. “Lower alkylene” refers to alkylene linkages containing from 1 to 12 carbon atoms, and includes, for example, methylene (—CH₂—), ethylene (—CH₂CH₂—), propylene (—CH₂CH₂CH₂—), 2-methylpropylene (—CH₂—CH(CH₃)—CH₂—), hexylene (—(CH₂)₆—) and the like. Similarly, the terms “alkenylene,” “alkynylene,” “arylene,” “alkarylene,” and “aralkylene” refer to difunctional (i.e., linking) alkenyl, alkynyl, aryl, alkaryl, and aralkyl groups, respectively.

The term “alkenyl” as used herein refers to a linear, branched or cyclic hydrocarbon group of 2 to about 50 carbon atoms containing at least one double bond, such as ethenyl, n-propenyl, isopropenyl, n-butenyl, isobutenyl, octenyl, decenyl, tetradecenyl, hexadecenyl, eicosenyl, tetracosenyl, and the like. Generally, although again not necessarily, alkenyl groups herein may contain 2 to about 36 carbon atoms, and for example may contain 2 to 12 carbon atoms. The term “lower alkenyl” intends an alkenyl group of 2 to 6 carbon atoms. The term “substituted alkenyl” refers to alkenyl substituted with one or more substituent groups, and the terms “heteroatom-containing alkenyl” and “heteroalkenyl” refer to alkenyl in which at least one carbon atom is replaced with a heteroatom. If not otherwise indicated, the terms “alkenyl” and “lower alkenyl” include linear, branched, cyclic, unsubstituted, substituted, and/or heteroatom-containing alkenyl and lower alkenyl, respectively. Similarly, the term “olefin,” as in an “olefinic compound” as used herein refers to a mono-unsaturated or di-unsaturated hydrocarbon of 2 to 36 carbon atoms, wherein in preferred embodiments a carbon-carbon double bond is positioned between the terminal 2 carbon atoms. Preferred olefinic groups within this class are sometimes herein designated as “lower olefinic groups,” intending a hydrocarbon containing 2 to 18 carbon atoms containing a single terminal double bond. The latter moieties may also be termed “lower alkenyl.” In some cases, it is a part of a silicon containing compound. Typically, but not necessarily, compounds containing olefinic groups are in a liquid form during use in the methods of the disclosure.

The term “alkynyl” as used herein refers to a linear or branched hydrocarbon group of 2 to 50 carbon atoms containing at least one triple bond, such as ethynyl, n-propynyl, and the like. Generally, although again not necessarily, alkynyl groups herein may contain 2 to about 18 carbon atoms, and such groups may further contain 2 to 12 carbon atoms. The term “lower alkynyl” intends an alkynyl group of 2 to 6 carbon atoms. The term “substituted alkynyl” refers to alkynyl substituted with one or more substituent groups, and the terms “heteroatom-containing alkynyl” and “heteroalkynyl” refer to alkynyl in which at least one carbon atom is replaced with a heteroatom. If not otherwise indicated, the terms “alkynyl” and “lower alkynyl” include linear, branched, unsubstituted, substituted, and/or heteroatom-containing alkynyl and lower alkynyl, respectively.

The terms “alkoxy” and “aryloxy” refer to an alkyl group and aryl group, respectively, bound through an oxygen linkage. In some embodiments, the alkyl or aryl group binds through the oxygen linkage to a non-carbon element, such as to a silicon atom. “Lower alkoxy” intends an alkoxy group containing 1 to 10, more preferably 1 to 7, carbon atoms. The terms “oxyalkylene” and “oxyarylene” refer to bifunctional (i.e., linking) alkoxy and aryloxy groups, respectively.

The term “aryl” as used herein refers to an aromatic species having 1 to 3 rings, but typically intends a monocyclic or bicyclic moiety, e.g., phenyl or 1- or 2-naphthyl groups. Optionally, these groups are substituted with 1 to 4, more preferably 1 to 2, substituents such as those described herein, including lower alkyl, lower alkoxy, hydroxyl, amino, and/or nitro. Aryl groups may, for example, contain 6 to 50 carbon atoms, and as a further example, aryl groups may contain 6 to 12 carbon atoms. For example, aryl groups may contain one aromatic ring or two fused or linked aromatic rings, e.g., phenyl, naphthyl, biphenyl, diphenylether, diphenylamine, benzophenone, and the like. “Substituted aryl” refers to an aryl moiety substituted with one or more substituent groups, and the terms “heteroatom-containing aryl” and “heteroaryl” refer to aryl substituent, in which at least one carbon atom is replaced with a heteroatom, as will be described in further detail infra. If not otherwise indicated, the term “aryl” includes unsubstituted, substituted, and/or heteroatom-containing aromatic substituents.

The term “aralkyl” refers to an alkyl group with an aryl substituent, and the term “alkaryl” refers to an aryl group with an alkyl substituent, wherein “alkyl” and “aryl” are as defined above. In general, aralkyl and alkaryl groups herein contain 6 to 50 carbon atoms. Aralkyl and alkaryl groups may, for example, contain 6 to 20 carbon atoms, and as a further example, such groups may contain 6 to 12 carbon atoms.

The term “amino” intends an amino group —NR₂ where R is hydrogen or an alternative substituent, typically lower alkyl. The term “amino” is thus intended to include primary amino (i.e., NH₂), “alkylamino” (i.e., a secondary amino group containing a single alkyl substituent), and “dialkylamino” (i.e., tertiary amino group containing two alkyl substituents).

The term “heteroatom-containing” as in a “heteroatom-containing alkyl group” (also termed a “heteroalkyl” group) or a “heteroatom-containing aryl group” (also termed a “heteroaryl” group) refers to a molecule, linkage or substituent in which one or more carbon atoms are replaced with an atom other than carbon, e.g., nitrogen, oxygen, sulfur, phosphorus or silicon, typically nitrogen, oxygen or sulfur. Similarly, the term “heteroalkyl” refers to an alkyl substituent that is heteroatom-containing, the term “heterocyclic” refers to a cyclic substituent that is heteroatom-containing, the terms “heteroaryl” and heteroaromatic” respectively refer to “aryl” and “aromatic” substituents that are heteroatom-containing, and the like. Examples of heteroalkyl groups include alkoxyaryl, alkylsulfanyl-substituted alkyl, N-alkylated amino alkyl, and the like. Examples of heteroaryl substituents include pyrrolyl, pyrrolidinyl, pyridinyl, quinolinyl, indolyl, furyl, pyrimidinyl, imidazolyl, 1,2,4-triazolyl, tetrazolyl, etc., and examples of heteroatom-containing alicyclic groups are pyrrolidino, morpholino, piperazino, piperidino, tetrahydrofuranyl, etc.

“Hydrocarbyl” refers to univalent hydrocarbyl radicals containing 1 to about 50 carbon atoms, including 1 to about 36 carbon atoms, further including 1 to about 18 carbon atoms, and further including about 1 to 12 carbon atoms, including linear, branched, cyclic, saturated and unsaturated species, such as alkyl groups, alkenyl groups, aryl groups, and the like. “Substituted hydrocarbyl” refers to hydrocarbyl substituted with one or more substituent groups, and the term “heteroatom-containing hydrocarbyl” refers to hydrocarbyl in which at least one carbon atom is replaced with a heteroatom such as O, N, P, Si, or S. Unless otherwise indicated, the term “hydrocarbyl” is to be interpreted as including substituted and/or heteroatom-containing hydrocarbyl moieties.

The term “ether” includes both mono and polyethers and refers to groups having a chain containing carbon and oxygen and each of these units consists of 2 to 6 carbons for each oxygen atom. Examples are diethyl and dipropyl ethers, polyethyleneoxide, polyprolyleneoxide, polyethelene glycol, polybuteleneoxide.

“Halo” or “halogen” refers to fluoro, chloro, bromo or iodo, and usually relates to halo substitution for a hydrogen atom in an organic compound.

As used herein, the term “perfluoro,” such as a perfluoro group, perfluoro monomer, perfluoro oligomer or perfluoro polymer, refers to a moiety or compound in which fluoro atoms substitute for hydrogen atom completely or almost completely. In some embodiments of perfluoro groups, the hydrogen atoms on between 1 and 3 carbons at a terminus or at a terminal bonding site (i.e., where the group attaches to a substrate or to another chemical moiety) are not replaced with fluoro atoms. Perfluoro groups further include polycarbon or polyether chains having the hydrogen atoms replaced with fluoro atoms.

The terms “halocarbyl” and “halocarbon” refer to hydrocarbyl groups (as defined above) for which one or more hydrogen radicals are replaced with halo radicals. Similarly, the term “perhalocarbyl” refers to hydrocarbyl groups for which all hydrogen radicals are replaced with halo radicals. The terms “halocarbyl” and “halocarbon” include perhalocarbyl, and further includes fluorocarbyl groups, perfluorinated hydrocarbyl groups, chlorocarbyl groups, perchlorinated hydrocarbyl groups, bromocarbyl groups, perbrominated hydrocarbyl groups, iodocarbyl groups, and periodinated hydrocarbyl groups. Similarly, the term “haloether” refers to an ether group in which one or more hydrogen radicals are replaced with halo radicals, and the term “perhaloether” refers to an ether in which all hydrogen radicals are replaced with halo radicals. The term “haloether” includes perhaloethers, unless otherwise specified.

By “substituted” as in “substituted hydrocarbyl,” “substituted alkyl,” “substituted aryl,” and the like, as alluded to in some of the aforementioned definitions, is meant that in the hydrocarbyl, alkyl, aryl, or other moiety, at least one hydrogen atom bound to a carbon (or other) atom is replaced with one or more non-hydrogen substituents. Examples of such substituents include, without limitation, functional groups and the hydrocarbyl moieties C₁-C₂₄ alkyl (including C₁-C₁₈ alkyl, further including C₁-C₁₂ alkyl, and further including C₁-C₆ alkyl), C₂-C₂₄ alkenyl (including C₂-C₁₈ alkenyl, further including C₂-C₁₂ alkenyl, and further including C₂-C₆ alkenyl), C₂-C₂₄ alkynyl (including C₂-C₁₈ alkynyl, further including C₂-C₁₂ alkynyl, and further including C₂-C₆ alkynyl), C₅-C₃₀ aryl (including C₅-C₂₀ aryl, and further including C₅-C₁₂ aryl), and C₆-C₃₀ aralkyl (including C₆-C₂₀ aralkyl, and further including C₆-C₁₂ aralkyl). By a “functional group” is meant a group that contains one or more reactive moieties. Examples of functional groups include halo, hydroxyl, sulfhydryl, C₁-C₂₄ alkoxy, C₂-C₂₄ alkenyloxy, C₂-C₂₄ alkynyloxy, C₅-C₂₀ aryloxy, acyl (including C₂-C₂₄ alkylcarbonyl (—CO-alkyl) and C₆-C₂₀ arylcarbonyl (—CO-aryl)), acyloxy (—O-acyl), C₂-C₂₄ alkoxycarbonyl (—(CO)—O-alkyl), C₆-C₂₀ aryloxycarbonyl (—(CO)—O-aryl), halocarbonyl (—CO)—X where X is halo), C₂-C₂₄ alkylcarbonato (—O—(CO)—O-alkyl), C₆-C₂₀ arylcarbonato (—O—(CO)—O-aryl), carboxy (—COOH), carboxylato (—COO—), carbamoyl (—(CO)—NH₂), mono-substituted C₁-C₂₄ alkylcarbamoyl (—(CO)—NH(C₁-C₂₄ alkyl)), di-substituted alkylcarbamoyl (—(CO)—N(C₁-C₂₄ alkyl)₂), mono-substituted arylcarbamoyl (—(CO)—NH-aryl), thiocarbamoyl (—(CS)—NH₂), carbamido (—NH—(CO)—NH₂), cyano (—C≡N), isocyano (—N+≡C—), cyanato (—O—C≡N), isocyanato (—O—N═C—), isothiocyanato (—S—C≡N), azido (—N═N+═N—), formyl (—(CO)—H), thioformyl (—(CS)—H), amino (—NH₂), mono- and di-(C₁-C₂₄ alkyl)-substituted amino, mono- and di-(C₅-C₂₀ aryl)-substituted amino, C₂-C₂₄ alkylamido (—NH—(CO)-alkyl), C₅-C₂₀ arylamido (—NH—(CO)-aryl), imino (—CR═NH where R=hydrogen, C₁-C₂₄ alkyl, C₅-C₂₀ aryl, C₆-C₂₀ alkaryl, C₆-C₂₀ aralkyl, etc.), alkylimino (—CR═N(alkyl), where R=hydrogen, alkyl, aryl, alkaryl, etc.), arylimino (—CR═N(aryl), where R=hydrogen, alkyl, aryl, alkaryl, etc.), nitro (—NO₂), nitroso (—NO), sulfo (—SO₂—OH), sulfonato (—SO₂—O—), C₁-C₂₄ alkylsulfanyl (—S-alkyl; also termed “alkylthio”), arylsulfanyl (—S-aryl; also termed “arylthio”), C₁-C₂₄ alkylsulfinyl (—(SO)-alkyl), C₅-C₂₀ arylsulfinyl (—(SO)-aryl), C₁-C₂₄ alkylsulfonyl (—SO₂-alkyl), C₅-C₂₀ arylsulfonyl (—SO₂-aryl), phosphono (—P(O)(OH)₂), phosphonato (—P(O)(O—)₂), phosphinato (—P(O)(O—)), phospho (—PO₂), and phosphino (—PH₂), mono- and di-(C₁-C₂₄ alkyl)-substituted phosphino, and mono- and di-(C₅-C₂₀ aryl)-substituted phosphino. In addition, the aforementioned functional groups may, if a particular group permits, be further substituted with one or more additional functional groups or with one or more hydrocarbyl moieties such as those specifically enumerated above. Analogously, the above-mentioned hydrocarbyl moieties may be further substituted with one or more functional groups or additional hydrocarbyl moieties such as those specifically enumerated.

When the term “substituted” appears prior to a list of possible substituted groups, it is intended that the term apply to every member of that group. For example, the phrase “substituted alkyl and aryl” is to be interpreted as “substituted alkyl and substituted aryl.”

The compounds described herein can contain one or more chiral centers and/or double bonds and therefore, can exist as stereoisomers, such as double-bond isomers (i.e., geometric isomers), enantiomers or diastereomers. Accordingly, all possible enantiomers and stereoisomers of the compounds including the stereoisomerically pure form (e.g., geometrically pure, enantiomerically pure or diastereomerically pure) and enantiomeric and stereoisomeric mixtures are included in the description of the compounds herein. Enantiomeric and stereoisomeric mixtures can be resolved into their component enantiomers or stereoisomers using separation techniques or chiral synthesis techniques well known to the skilled artisan. The compounds can also exist in several tautomeric forms including the enol form, the keto form and mixtures thereof. Accordingly, the chemical structures depicted herein encompass all possible tautomeric forms of the illustrated compounds. The compounds described also include isotopically labeled compounds where one or more atoms have an atomic mass different from the atomic mass conventionally found in nature. Examples of isotopes that can be incorporated into the compounds disclosed herein include, but are not limited to, ²H, ³H, ¹¹C, ¹³C, ¹⁴C, ¹⁵N, ¹⁸O, ¹⁷O, etc. Compounds can exist in unsolvated forms as well as solvated forms, including hydrated forms. In general, compounds can be hydrated or solvated. Certain compounds can exist in multiple crystalline or amorphous forms. In general, all physical forms are equivalent for the uses contemplated herein and are intended to be within the scope of the present disclosure.

### DETAILED DESCRIPTION

Drying agents that include a metal organic salt of an α-hydroxy acid for use as a drier in liquid compositions (e.g., coatings, inks, lubes, greases) are provided. Compositions having a waterborne (e.g., waterborne alkyd resin, waterborne urethane resin, such as an oil-modified urethane resin, etc.) or an oil-based (e.g., oil-based alkyd resin, oil-based urethane resin, etc.) composition and a drying agent that includes a metal organic salt of an α-hydroxy acid are also described. Also provided are methods of producing a coating on a surface by applying to the surface a composition having a one or more of the subject drying agents. Methods for preparing an air-drying composition by combining a waterborne or oil-based composition and a drying agent having a metal organic salt of an α-hydroxy acid are also described.

Before the present invention is described in greater detail, it is to be understood that this invention is not limited to particular embodiments described, as such may, of course, vary. It is also to be understood that the terminology used herein is for the purpose of describing particular embodiments only, and is not intended to be limiting, since the scope of the present invention will be limited only by the appended claims.

Where a range of values is provided, it is understood that each intervening value, to the tenth of the unit of the lower limit unless the context clearly dictates otherwise, between the upper and lower limit of that range and any other stated or intervening value in that stated range, is encompassed within the invention. The upper and lower limits of these smaller ranges may independently be included in the smaller ranges and are also encompassed within the invention, subject to any specifically excluded limit in the stated range. Where the stated range includes one or both of the limits, ranges excluding either or both of those included limits are also included in the invention.

Certain ranges are presented herein with numerical values being preceded by the term “about.” The term “about” is used herein to provide literal support for the exact number that it precedes, as well as a number that is near to or approximately the number that the term precedes. In determining whether a number is near to or approximately a specifically recited number, the near or approximating unrecited number may be a number which, in the context in which it is presented, provides the substantial equivalent of the specifically recited number.

Unless defined otherwise, all technical and scientific terms used herein have the same meaning as commonly understood by one of ordinary skill in the art to which this invention belongs. Although any methods and materials similar or equivalent to those described herein can also be used in the practice or testing of the present invention, representative illustrative methods and materials are now described.

All publications and patents cited in this specification are herein incorporated by reference as if each individual publication or patent were specifically and individually indicated to be incorporated by reference and are incorporated herein by reference to disclose and describe the methods and/or materials in connection with which the publications are cited. The citation of any publication is for its disclosure prior to the filing date and should not be construed as an admission that the present invention is not entitled to antedate such publication by virtue of prior invention. Further, the dates of publication provided may be different from the actual publication dates which may need to be independently confirmed.

It is noted that, as used herein and in the appended claims, the singular forms “a”, “an”, and “the” include plural referents unless the context clearly dictates otherwise. It is further noted that the claims may be drafted to exclude any optional element. As such, this statement is intended to serve as antecedent basis for use of such exclusive terminology as “solely,” “only” and the like in connection with the recitation of claim elements, or use of a “negative” limitation.

As will be apparent to those of skill in the art upon reading this disclosure, each of the individual embodiments described and illustrated herein has discrete components and features which may be readily separated from or combined with the features of any of the other several embodiments without departing from the scope or spirit of the present invention. Any recited method can be carried out in the order of events recited or in any other order which is logically possible.

In further describing embodiments of the present disclosure, drying agents that include a metal organic salt of an α-hydroxy acid for use as a drier in liquid (e.g., coatings, inks, lubes, greases) compositions are reviewed first in greater detail, followed by a description of compositions having a waterborne or oil-based composition, such as a waterborne alkyd resin or an oil-based urethane and a drying agent that includes a metal organic salt of an α-hydroxy acid This is followed by a detailed description of embodiments of applying compositions having the subject drying agents that include a metal organic salt of α-hydroxy acid to form a coating on a support surface. Next, methods for preparing the compositions are provided. Kits including one or more of the subject drying agents are also described.

### Drying Agents Having a Metal Organic Salt of an α-Hydroxy Acid

As summarized above, aspects of the disclosure include a drying agent that includes a metal organic of an α-hydroxy acid for use as a drier in liquid (e.g., coatings, inks, lubes, greases) compositions. The term “drying agent” is used herein in its conventional sense to refer to one or more compounds which enhances drying of a composition, such as compared to a suitable control composition that is identical to the subject composition but for the presence of the drying agent (such as described in greater detail below). As described herein, “enhancing” the drying of the a composition may include one or more of accelerating the initiation (i.e., reducing the amount time for drying to begin) of composition drying, increasing the overall rate of composition drying (i.e., reducing the amount of time for composition curing to be complete) and increasing the overall extent of composition drying. In certain embodiments, “drying” includes becoming hard and free of liquid.

In some embodiments, drying agents of interest accelerate the initiation of composition drying, such as by reducing the required time for the composition to begin drying by 5% or more, such as by 10% or more, such as by 25% or more, such as by 50% or more, such as by 75% or more, such as by 90% or more, such as 95% or more, as compared to a suitable control. For example, drying agents of interest may reduce the amount of time required for the composition to begin drying by 0.1 hours or more, such as by 0.5 hours or more, such as by 1 hour or more, such as by 1.5 hours or more, such as by 2 hours or more and including reducing the amount of time required for the composition to begin drying by 6 hours or more.

In other embodiments, drying agents of interest accelerate the overall rate of composition drying, such as by reducing the total amount of time for the composition to complete drying by 2% or more, such as by 5% or more, such as by 10% or more, such as by 25% or more, such as by 50% or more, such as by 75% or more, such as by 100% or more, such as by 200% or more, including by 500% or more, as compared to a suitable control. For example, drying agents of interest may reduce the total amount of time for the composition to complete drying by 0.5 hours or more, such as by 1 hour or more, such as by 2 hours or more, such as by 3 hours or more, such as by 6 hours or more, such as by 12 hours or more and including reducing the total amount of time for the composition to dry completely by 24 hours or more.

In still other embodiments, drying agents of interest increase the overall extent of composition drying. For example, drying agents may increase the extent of composition drying by 1% or more, such as by 5% or more, such as by 10% or more, such as by 25% or more, such as by 50% or more, such as by 75% or more, such as by 90% or more, such as 95% or more and including increasing the extent of composition drying by 99% or more.

In embodiments, the subject drying agents can be stably incorporated into waterborne and oil-based compositions. As discussed in greater detail below, the term “waterborne” is used herein in its conventional sense to refer to compositions in which water is the primary solvent, such as where water is present in the composition at a weight percentage of 25% w/w water or greater, such as 30% w/w water or greater, such as 35% w/w or greater, such as 40% w/w water or greater, such as 45% w/w or greater, such as 50% w/w or greater, such as 60% w/w or greater, such as 70% w/w or greater, such as 80% w/w or greater, such as 90% w/w or greater and including a medium that is 95% w/w water or greater. Accordingly, drying agents as described herein may be stably incorporated into compositions where water is present in the composition at a weight percentage of 25% or more, such as 50% or more, such as 75% or more, such as 90% or more, such as 95% or more and including compositions having a weight percent of water which is 97% or more.

In other embodiments, the subject drying agents can be stably incorporated into oil-based compositions (e.g., oil-based urethane), where the primary solvent is non-polar. For example, the subject drying agents are capable of being stably incorporated into compositions in which the primary solvent is nonpolar and is present in the composition at a weight percentage of 25% w/w or greater, such as 30% w/w or greater, such as 35% w/w or greater, such as 40% w/w or greater, such as 45% w/w or greater, such as 50% w/w or greater, such as 60% w/w or greater, such as 70% w/w or greater, such as 80% w/w or greater, such as 90% w/w or greater and including 95% w/w or greater.

As summarized above, the subject drying agents include a drying agent that includes a metal organic salt of an α-hydroxy acid for use as a drier in liquid (e.g., coatings, inks, lubes, greases) compositions. The term “α-hydroxy acid” is used in its conventional sense to refer to the class of chemical compounds having a carboxylic acid substituted with a hydroxyl group on an adjacent carbon, such as for example, a compound defined by the formula:

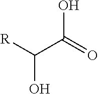

where R is hydrogen, alkyl, substituted alkyl, cycloalkyl, substituted cycloalkyl, aryl or substituted aryl. In certain embodiments, R is hydrogen. In other embodiments, R is a C1-C12 alkyl, such as methyl or a carboxylic acid substituted alkyl. In yet other embodiments, R is aryl. For example, α-hydroxy acids of interest include glycolic acid, lactic acid, tartaric acid, citric acid, malic acid and mandelic acid and combinations thereof, among others. In certain embodiments, drying agents of interest include a metal organic salt of glycolic acid. In other embodiments, drying agents of interest include a metal organic salt of lactic acid.

Drying agents of interest include metal organic salts of an α-hydroxy acid. Depending on the α-hydroxy acid, metal organic salts of interest may vary, where metals of interest include, but are not limited to, cobalt (Co), manganese (Mn), vanadium (V), iron (Fe), copper (Cu), titanium (Ti), cerium (Ce), zirconium (Zr), neodymium (Nd), calcium (Ca), strontium (Sr), zinc (Zn) as well as combinations thereof. For example, the subject metal organic salts of α-hydroxy acids may be Co(II), Co(III), Cu (II), Cu (III), V(II), V(III), Fe(II), Fe(III), Mn(II), Mn(III), Mn(IV), Ce(II), Ce(III), Ce(IV), Zr (IV), Nd (III), Ca (II), Sr (II), Zn (II) or a combination thereof. In certain embodiments, drying agents of interest include a cobalt salt of an α-hydroxy acid. In other embodiments, drying agents of interest include a manganese salt of α-hydroxy acid. For example, drying agents of interest may include, but are not limited to a cobalt salt of glycolic acid, a cobalt salt of lactic acid, a manganese salt of glycolic acid and a manganese salt of lactic acid. In other embodiments, drying agents of interest include a zirconium salt of α-hydroxy acid. In other embodiments, drying agents of interest include a calcium salt of α-hydroxy acid.

Any suitable combination of metal and α-hydroxy acid may be employed so long as the metal organic salt of the α-hydroxy acid enhances drying of the subject compositions as desired. In some embodiments, drying agents include one or more different types of α-hydroxy acid metal organic salts, such as two or more, such as three or more, such as four or more, such as five or more and including ten or more different types of α-hydroxy acid metal organic salts. The drying agents may include one or more different types of α-hydroxy acids, such as two or more, such as three or more, such as four or more and including five or more different types of α-hydroxy acids. In other embodiments, drying agents include one or more different types of metals, such as two or more, such as three or more, such as four or more and include five or more different types of metals.

### Compositions Having a Waterborne Composition and Drying Agent

As summarized above, aspects of the present disclosure also include compositions having a waterborne or oil-based composition and a drying agent that includes a metal organic salt of an α-hydroxy acid. In some embodiments, compositions include a waterborne binder, e.g., waterborne alkyd resin, and drying agents of interest are capable of being stably incorporated into the waterborne binder, e.g., waterborne alkyd resin, in the absence of a surfactant. By “binder” is meant a liquid component of a composition, where the liquid component is capable of curing/hardening under a suitable condition, e.g., under exposure to air, as described below. By “absence of surfactant” is meant that the metal organic salt of the α-hydroxy acid may be stably incorporated into the waterborne binder, e.g., waterborne alkyd resin, with little or no surfactant to co-mix the drying agent into the binder, e.g., waterborne alkyd resin, such as where the amount of surfactant present is 1% by weight or less, such as 0.5% by weight or less, such as 0.1% by weight or less, such as 0.05% by weight or less, such as 0.01% by weight or less, such as 0.005% by weight or less, such as 0.001% by weight or less, such as 0.0001% by weight or less and including 0.00001% by weight or less. The surfactant may be an ionic or nonionic surfactant. For example, surfactants may include ethoxylated surfactants, sulfated surfactants, etc. Ethoxylated surfactants may include secondary alcohol ethoxylates, alkyl polyethylene glycol ethers formed from a C₁₀-alcohol and ethylene oxide, ethylene oxide/propylene oxide block copolymers with primary OH groups, propylene oxide/ethylene oxide block copolymers with secondary OH groups, ethoxylated tristyrylphenols, tridecyl alcohol ethoxylates, ethoxylated branched alcohol phosphate esters, etc., and mixtures thereof. Sulfated surfactants may include sodium dodecyl sulfate, etc.

In certain embodiments, no surfactant (i.e., 0% by weight) is needed to co-mix the drying agent into the waterborne binder, e.g., waterborne alkyd resin. In other embodiments, compositions include an oil-modified urethane as binder, and drying agents of interest are capable of being stably incorporated into the oil-modified urethane.

Compositions according to certain embodiments include a drying agent having a metal organic salt of an α-hydroxy acid and a waterborne binder, e.g., waterborne alkyd resin. As described in greater detail below, drying these compositions may include crosslinking a waterborne crosslinkable polymer precursor. In these embodiments, the drying agent enhances crosslinking of the waterborne crosslinkable polymer precursor, such as by accelerating the initiation (i.e., reducing the amount time for crosslinking to begin) of crosslinking of the waterborne crosslinkable polymer precursor, raising the overall rate of crosslinking (i.e., reducing the total amount of time for crosslinking the waterborne crosslinkable polymer precursor to completion) as well as increasing the overall extent of crosslinking.

In one example, drying agents of interests reduce the amount of time required for the crosslinking of the waterborne crosslinkable polymer precursor to begin by 5% or more, such as by 10% or more, such as by 25% or more, such as by 50% or more, such as by 75% or more, such as by 90% or more, such as 95% or more, as compared to a suitable control. For instance, the amount of time required to initiate crosslinking the waterborne crosslinkable polymer precursor may be reduced by 0.1 hours or more, such as by 0.5 hours or more, such as by 1 hour or more, such as by 1.5 hours or more, such as by 2 hours or more and including reducing the amount of time required for the crosslinking of the waterborne crosslinkable polymer precursor to begin by 6 hours or more.

In another example, drying agents increase the rate of crosslinking of the waterborne crosslinkable polymer precursor by 2% or more, such as by 5% or more, such as by 10% or more, such as by 25% or more, such as by 50% or more, such as by 75% or more, such as by 100% or more, such as by 200% or more, including by 500% or more, as compared to a suitable control. For instance, the total amount of time required to complete crosslinking of the crosslinkable polymer precursor by 0.5 hours or more, such as by 1 hour or more, such as by 2 hours or more, such as by 3 hours or more, such as by 6 hours or more, such as by 12 hours or more and including reducing the total amount of time for the composition to complete crosslinking of the crosslinkable polymer precursor by 24 hours or more.

In yet another example, drying agents increase the overall extent of crosslinking of the waterborne crosslinkable polymer precursor by 1% or more, such as by 5% or more, such as by 10% or more, such as by 25% or more, such as by 50% or more, such as by 75% or more, such as by 90% or more, such as 95% or more and including increasing the extent of crosslinking by 99% or more.

In some instances, the subject composition is an air-drying medium and drying agents of interest enhance air-drying of the compositions. The term “air-drying” is used herein in its conventional sense to refer to contacting the subject compositions to a gaseous composition, such as atmospheric air, to dry the composition. Air-drying, according to certain embodiments, includes exposing the composition to a gaseous composition having one or more gaseous components, such as two or more gaseous components, such as three or more, such as four or more, such as five or more and including ten or more gaseous components. For example, air-drying may include contacting the subject compositions having an air-drying binder, e.g., alkyd resin, and drying agent with a gaseous composition containing one or more of oxygen, nitrogen, helium, hydrogen, argon, xenon, carbon dioxide, carbon monoxide, among other gases. In some embodiments, air-drying includes contacting with an oxygen gas. In other embodiments, air-drying includes contacting with atmospheric air. Air-drying may also include contacting the subject compositions having a waterborne binder, e.g., waterborne alkyd resin, and drying agent with a gaseous composition under modified pressure conditions. For example, in some instances the subject compositions are contacted with the gaseous composition under increased pressure relative to atmospheric pressure, such as under a pressure of 0.001 kPa or more above atmospheric pressure, such as 0.005 kPa or more, such as 0.01 kPa or more, such as 0.05 kPa or more, such as 0.1 kPa or more, such as 0.5 kPa or more, such as 1 kPa or more, such as 2.5 kPa or more, such as 5 kPa or more, such as 10 kPa or more and including under a pressure of 25 kPa or more above atmospheric pressure. In other instances, the subject compositions are contacted with the gaseous composition under reduced pressure relative to atmospheric pressure, such as under a pressure of 0.001 kPa or below atmospheric pressure, such as 0.005 kPa or more, such as 0.01 kPa or more, such as 0.05 kPa or more, such as 0.1 kPa or more, such as 0.5 kPa or more, such as 1 kPa or more, such as 2.5 kPa or more, such as 5 kPa or more, such as 10 kPa or more and including under a pressure of 25 kPa or more below atmospheric pressure.

Compositions of interest according to certain embodiments include a waterborne binder, e.g., waterborne alkyd resin, and a drying agent having a metal organic salt of an α-hydroxy acid. As discussed above, α-hydroxy acids of interest include compounds having a carboxylic acid substituted with a hydroxyl group on an adjacent carbon. For example, α-hydroxy acids of interest may include but are not limited to glycolic acid, lactic acid, tartaric acid, citric acid, malic acid and mandelic acid and combinations thereof, among others. In certain embodiments, drying agents of interest include a metal organic salt of glycolic acid. In other embodiments, drying agents of interest include a metal organic salt of lactic acid.

Drying agents of interest are metal organic salts of an α-hydroxy acid. Depending on the α-hydroxy acid, metal organic salts of interest may include but are not limited to a variety of different metals, such as but not limited to cobalt (Co), manganese (Mn), vanadium (V), iron (Fe), copper (Cu), titanium (Ti), cerium (Ce), zirconium (Zr), neodymium (Nd), calcium (Ca), strontium (Sr), zinc (Zn) as well as combinations thereof. For example, the subject metal organic salts of α-hydroxy acids may be Co(II), Co(III), Cu (II), Cu (III), V(II), V(III), Fe(II), Fe(III), Mn(II), Mn(III), Mn(IV), Ce(II), Ce(III), Ce(IV), Zr (IV), Nd (III), Ca (II), Sr (II), Zn (II) or a combination thereof. In certain embodiments, drying agents of interest include a cobalt salt of an α-hydroxy acid. In other embodiments, drying agents of interest include a manganese salt of α-hydroxy acid. For example, drying agents of interest may include, but are limited to a cobalt salt of glycolic acid, a cobalt salt of lactic acid, a manganese salt of glycolic acid and a manganese salt of lactic acid. In other embodiments, drying agents of interest include a zirconium salt of α-hydroxy acid. In other embodiments, drying agents of interest include a calcium salt of α-hydroxy acid.

Any suitable combination of metal and α-hydroxy acid may be employed so long as the metal organic salt of the α-hydroxy acid enhances drying of the subject compositions as desired. In some embodiments, drying agents include one or more different types of α-hydroxy acid metal organic salts, such as two or more, such as three or more, such as four or more, such as five or more and including ten or more different types of α-hydroxy acid metal organic salts. The drying agents may include one or more different types of α-hydroxy acids, such as two or more, such as three or more, such as four or more and including five or more different types of α-hydroxy acids. In other embodiments, drying agents include one or more different types of metals, such as two or more, such as three or more, such as four or more and include five or more different types of metals.

Depending on the type of waterborne binder, e.g., waterborne alkyd resin (as described in greater detail below), the amount of the metal organic salt of the α-hydroxy acid in the subject compositions may vary, such as 0.0001 wt % or greater, such as 0.001 wt % or greater, such as 0.001 wt % or greater, such as 0.01 wt % or greater, such as 0.1 wt % or greater, such as 1 wt % or greater, such as 1.5 wt % or greater, such as 2 wt % or greater, such as 2.5 wt % or greater, such as 3 wt % or greater, such as 3.5 wt % or greater, such as 4 wt % or greater, such as 4.5 wt % or greater and including in an amount of about 5 wt % or greater. In some embodiments, the amount of α-hydroxy acid metal salt in the subject compositions ranges from 0.0001% to 5% w/w, such as from 0.005% to 4.5% w/w, such as from 0.01% to 4%, such as from 0.05% to 3.5% w/w and including 0.1% to 3% w/w.

The weight ratio of the α-hydroxy acid metal organic salt to waterborne binder, e.g., waterborne alkyd resin, in the subject compositions varies, such as a ratio of 1:1 or greater, such as 1:2 or greater, such as 1:3 or greater, such as 1:5 or greater, such as 1:10 or greater, such as 1:25 or greater, such as 1:50 or greater, such as 1:100 or greater, such as 1:250 or greater, such as 1:500 or greater, such as 1:1000 or greater, such as 1:5000 or greater and including a weight ratio of α-hydroxy acid metal organic salt to waterborne binder, e.g., waterborne alkyd resin, of 1:100000 or greater. For example, the weight ratio of the α-hydroxy acid metal organic salt to waterborne binder, e.g., waterborne alkyd resin, may range from 1:1 to 1:75000, such as from 1:2 and 1:50000, such as from 1:5 and 1:25000, such as from 1:10 and 1:15000, such as from 1:100 to 1:10000 and including a weight ratio of α-hydroxy acid metal organic salt to waterborne binder, e.g., waterborne alkyd resin, from 1:500 and 1:5000.

Compositions of the present disclosure according to certain embodiments include a waterborne binder, e.g., waterborne alkyd resin, and a drying agent having a metal organic salt of an α-hydroxy acid. The term “waterborne” is used herein in its conventional sense to refer to compositions in which water is the primary solvent, such as where water is present in the composition at a weight percentage of 25% or more, such as 50% or more, such as 75% or more, such as 90% or more, such as 95% or more and including compositions having a weight percent of water which is 97% or more. In other words, the medium of the binder, e.g., alkyd resin, is, in embodiments of the present disclosure, 25% w/w water or greater, such as 30% w/w water or greater, such as 35% w/w or greater, such as 40% w/w water or greater, such as 45% w/w or greater, such as 50% w/w or greater, such as 60% w/w or greater, such as 70% w/w or greater, such as 80% w/w or greater, such as 90% w/w or greater and including a medium that is 95% w/w water or greater.

In some embodiments, a composition of the present disclosure is substantially free of any conventional drying agents. A conventional drying agent may include an organometallic salt, such as a metal carboxylate. In some cases, a conventional drying agent includes a branched C₇-C₁₉ monocarboxylic acid. Examples of carboxylates that may be used in a conventional drying agent includes acetates, propionates, octoates, tallates (linoresinates), rosinates (abietates), laurates, oleates, octadecanoates, neodecanoates, linoleates, naphthenates, versatates, or hexanoates, and may include 2-ethylhexanoate, isononanoate, etc. A drying agent of the present disclosure, that includes a metal organic salt of an α-hydroxy acid, may provide substantially the same, or faster, rate of drying (e.g., rate of initiation, overall rate, and/or extent of drying) of a liquid composition (e.g., waterborne or oil-based composition) relative to a comparable liquid composition that uses a conventional drying agent instead of the metal organic salt of an α-hydroxy acid. In some cases, the drying rate of a liquid composition achieved by using a cobalt or manganese salt of an α-hydroxy acid, according to embodiments of the present disclosure, is substantially the same, or faster, than the drying rate of a comparable liquid composition achieved by using a cobalt or manganese salt of a conventional drying agent, e.g., a cobalt or manganese salt of a carboxylate.

In some embodiments, a composition of the present disclosure having a drying agent that includes a metal organic salt of an α-hydroxy acid includes a conventional drying agent, as described above, in an amount that is reduced compared to a composition that includes only a conventional drying agent, to achieve substantially the same rate of drying.

In certain embodiments, waterborne compositions of interest include one or more water-miscible co-solvents with water. For example, waterborne compositions may include two or more water-miscible co-solvents with water, such as three or more, such as four or more and including five or more water-miscible co-solvents with water. In embodiments, water miscible co-solvents in compositions of interest may include, but are not limited to, glycols, glycol ethers, acetaldehyde, acetic acid, acetone, acetonitrile, 1,2-butanediol, 1,3-butanediol, 1,4-butanediol, 2-butoxyethanol, butyric acid, diethanolamine, diethylenetriamine, dimethylformamide, dimethoxyethane, dimethyl sulfoxide, 1,4-dioxane, ethanol, ethylamine, ethylene glycol, formic acid, furfuryl alcohol, glycerol, methanol, methyl diethanolamine, methyl isocyanide, 1-propanol, 1,3-propanediol, 1,5-pentanediol, 2-propanol, propanoic acid, propylene glycol, pyridine, tetrahydrofuran, triethylene glycol.

Where waterborne compositions include one or more co-solvents with water, the amount of co-solvent in the composition may vary, ranging from 0.001% to 10% w/w, such as from 0.005% to 9% w/w, such as from 0.01% to 8% w/w, such as from 0.05% to 7% w/w, such as from 0.1% to 6% w/w, such as from 0.5% to 5% and including from 1% to 4% w/w. In some embodiments, waterborne compositions include 10% w/w or less of the co-solvent, such as 9% w/w or less, such as 4% w/w or less, such as 7% w/w or less, such as 6% w/w or less, such as 5% w/w or less, such as 4% w/w or less, such as 3% w/w or less, such as 2% w/w or less, such as 1% w/w or less and including 0.1% w/w or less of a co-solvent. In some embodiments, waterborne compositions do not include any co-solvents with water.

Any suitable binder that can be cured by a metal drier may be used in the compositions of the present disclosure. Suitable binders of interest include, without limitation, alkyd, polyester, polyacrylate, or polyurethane binders, and combinations thereof. Where the binder includes a polyester or polyurethane, the binder may include a crosslinkable media that includes, e.g., vinyl- or other alkene-containing monomers, etc. In some embodiments, the binder includes an oil-modified urethane (e.g., where the isocyanate component of the resin is pre-reacted with oils), such as a waterborne oil-modified urethane. In some embodiments, the binder includes an alkyd resin.

Alkyd resins of interest include a waterborne crosslinkable polymer precursor composition. The term “crosslink” is used its conventional sense to refer to the physical (e.g., intermolecular interactions or entanglements, such as through hydrophobic interactions) or chemical (e.g., covalent bonding) interaction between backbone components of the subject polymer precursors. As described in greater detail below, the subject waterborne crosslinkable polymer precursor composition is subjected to crosslinking conditions to form a crosslinked polymer. The crosslinkable polymer precursor composition may be crosslinked by any convenient crosslinking protocol, including but not limited to chemically-initiated crosslinking, oxidative crosslinking, photo-initiated crosslinking as well as crosslinking initiated by changes in heat, pressure or pH. In some instances, crosslinking the crosslinkable polymer precursor includes an oxidative process. In other instances, crosslinking the crosslinkable polymer precursor includes reaction of carbon-carbon double or carbon-carbon triple bonds present in the crosslinkable polymer. In certain embodiments, crosslinking the crosslinkable polymer precursor composition includes contacting the crosslinkable polymer precursor composition to atmospheric air for a duration sufficient to oxidatively crosslink the crosslinkable polymer through carbon-carbon double or carbon-carbon triple bonds.

In some embodiments, waterborne crosslinkable polymer precursors include unsaturated polyesters prepared from a polyol and a polycarboxylic acid or polycarboxylic anhydride. In certain instances, waterborne crosslinkable polymer precursors include unsaturated polyesters prepared from unsaturated polyester is prepared from a polyol, a polycarboxylic acid or polycarboxylic anhydride and an unsaturated fatty acid (i.e., contains one or more carbon-carbon double bond or carbon-carbon triple bond).

The polyol may include two or more hydroxyl groups, such as three or more, such as four or more and including five or more hydroxyl groups. For example, the polyol may be a polyhydric alcohol such as glycerol, propylene glycol, neopentyl glycol, diethylene glycol, pentaerythritol, dipentaerythritol, ethylene glycol, trimethylolpropane, trimethylol ethane, di-trimethylol propane, 1,6-hexane diol and combinations thereof. In some embodiments, the polyol is glycerol. In certain instances, the polyol is propylene glycol.

The polyol component may have a molecular weight which varies depending on the properties of the alkyd resin desired (e.g., wettability, mechanical properties, resistance to degradation, etc.), and may be 0.1 kDa or greater, such as 0.125 kDa or greater, such as 0.15 kDa or greater and including 0.25 kDa or greater, such as 0.5 kDa or greater, such as 0.75 kDa or greater and including 1 kDa or greater. Likewise, the amount of polyol in waterborne crosslinkable polymer precursors of interest may vary. For instance, polyol may be present in the subject waterborne crosslinkable polymer precursors in an amount ranging from 1% to 50% w/w, such as 2% to 49% w/w, such as 5% to 45% w/w, such as 10% to 40% w/w, such as 15% to 35% w/w and including 20% to 30% w/w.

In some embodiments, waterborne crosslinkable polymer precursors include unsaturated polyesters prepared from a polyol and a polycarboxylic acid. The polycarboxylic acid may include two or more carboxylic acid groups, such as three or more, such as four or more and including five or more carboxylic acid groups. Suitable polycarboxylic acids include dicarboxylic acids, tricarboxylic acids, tetracarboxylic acids, pentacarboxylic acids, as well as higher polycarboxylic acids. The polycarboxylic acid may include aromatic, aliphatic and cycloaliphatic polycarboxylic acids. For example, the polycarboxylic acid may be a polyacid such as maleic acid, fumaric acid, adipic acid, azelaic acid, phthalic acid and its regio-isomeric analogues, trimellitic acid, pyromellitic acid, pimelic acid, sebacic acid and tetra-hydrophthalic acid and combinations thereof.

The polycarboxylic acid may have a molecular weight which varies depending on the properties of the alkyd resin desired (e.g., wettability, mechanical properties, resistance to degradation), and may be 0.25 kDa or greater, such as 0.5 kDa or greater, such as 0.75 kDa or greater, such as 1 kDa or greater, such as 1.5 kDa or greater, such as 2 kDa or greater, such as 2.5 kDa or greater, and including 3 kDa or greater. Likewise, the amount of polycarboxylic acid in waterborne crosslinkable polymer precursors of interest may vary. For instance, polycarboxylic acid may be present in the subject waterborne crosslinkable polymer precursors in an amount ranging from 1% to 50% w/w, such as 2% to 49% w/w, such as 5% to 45% w/w, such as 10% to 40% w/w, such as 15% to 35% w/w and including 20% to 30% w/w.

In certain embodiments, the subject waterborne crosslinkable polymer precursor compositions include unsaturated polyesters prepared from a polyol and a polycarboxylic acid anhydride. For example, the polycarboxylic anhydride may be an aromatic, aliphatic or cycloaliphatic polycarboxylic acid anhydrides. For example, the polycarboxylic acid anhydride may be maleic anhydride, fumaric anhydride, adipic anhydride, azelaic anhydride, phthalic acid anhydride and its regio-isomeric analogues, trimellitic anhydride, pyromellitic anhydride, pimelic acid anhydride, sebacic anhydride and tetra-hydrophthalic anhydride and combinations thereof.

The polycarboxylic acid anhydride may have a molecular weight which varies depending on the properties of the alkyd resin desired (e.g., wettability, mechanical properties, resistance to degradation), and may be 0.25 kDa or greater, such as 0.5 kDa or greater, such as 0.75 kDa or greater, such as 1 kDa or greater, such as 1.5 kDa or greater, such as 2 kDa or greater, such as 2.5 kDa or greater, and including 3 kDa or greater. Likewise, the amount of polycarboxylic anhydride in waterborne crosslinkable polymer precursors of interest may vary. For instance, polycarboxylic anhydride may be present in the subject waterborne crosslinkable polymer precursors in an amount ranging from 1% to 50% w/w, such as 2% to 49% w/w, such as 5% to 45% w/w, such as 10% to 40% w/w, such as 15% to 35% w/w and including 20% to 30% w/w.

In some embodiments, the ratio of the polyol to the polycarboxylic acid or polycarboxylic acid anhydride may vary, ranging between 10:1 and 9.5:1; 9.5:1 and 9:1; 9:1 and 8.5:1; 8.5:1 and 8:1; 8:1 and 7.5:1; 7.5:1 and 7:1; 7:1 and 6.5:1; 6.5:1 and 6:1; 6:1 and 5.5:1; 5.5:1 and 5:1; 5:1 and 4.5:1; 4.5:1 and 4:1; 4:1 and 3.5:1; 3.5:1 and 3:1; 3:1 and 2.5:1; 2.5:1 and 2:1; 2:1 and 1.5:1; 1.5:1 and 1:1 or a range thereof. For example, the mass ratio of the polyol to the polycarboxylic acid or polycarboxylic acid anhydride may range from 10:1 and 1:1, such as 8:1 and 1:1, such as 5:1 and 1:1, such as 4:1 and 1:1, and including from 2:1 and 1:1. In certain instances, the ratio of polyol to the polycarboxylic acid or polycarboxylic acid anhydride is 1:1.

In other embodiments, the ratio of polyol to the polycarboxylic acid or polycarboxylic acid anhydride in the subject hydrogels may vary, in some embodiments ranging between 1:1 and 1:1.5; 1:1.5 and 1:2; 1:2 and 1:2.5; 1:2.5 and 1:3; 1:3 and 1:3.5; 1:3.5 and 1:4; 1:4 and 1:4.5; 1:4.5 and 1:5; 1:5 and 1:5.5; 1:5.5 and 1:6; 1:6 and 1:6.5; 1:6.5 and 1:7; 1:7 and 1:7.5; 1:7.5 and 1:8; 1:8 and 1:8.5; 1:8.5 and 1:9; 1:9 and 1:9.5; 1:9.5 and 1:10 or a range thereof. For example, the ratio of polyol to the polycarboxylic acid or polycarboxylic acid anhydride may range from 1:1 and 1:10, such as 1:1 and 1:8, such as 1:1 and 1:5, such as 1:1 and 1:4, and including from 1:1 and 1:2.

In some embodiments, the polyol, the polycarboxylic acid or polycarboxylic acid anhydride or both the polyol and polycarboxylic acid or polycarboxylic acid anhydride are unsaturated. The term “unsaturated” is used herein in its conventional sense to refer to having one or more carbon-carbon double or triple bonds, such as for example two or more carbon-carbon double or triple bonds, such as three or more carbon-carbon double or triple bonds, such as five or more carbon-carbon double or triple bonds and including ten or more carbon-carbon double or triple bonds. In some embodiments, the polyol is unsaturated. In other embodiments, the polycarboxylic acid or polycarboxylic acid anhydride is unsaturated. In yet other embodiments, the polyol and the polycarboxylic acid or polycarboxylic acid anhydride are both unsaturated.

In certain embodiments, the waterborne crosslinkable polymer precursor composition includes unsaturated polyesters prepared from a polyol, a polycarboxylic acid or a polycarboxylic acid anhydride and one or more unsaturated fatty acids. Unsaturated fatty acids of interest may include conjugated or non-conjugated fatty acids derived from natural or synthetic oils, such as C₂-C₂₄ carboxylic acids. For example, unsaturated fatty acids of interest may include, but are not limited to linoleic acid, linolenic acid, oleic acid, ricinoleic acid, licanic acid and eleostearic acids and combinations thereof.

Unsaturated fatty acids of interest may have a molecular weight which varies depending on the properties of the alkyd resin desired (e.g., wettability, mechanical properties, resistance to degradation), and may in some instances be 0.25 kDa or greater, such as 0.5 kDa or greater, such as 0.75 kDa or greater, such as 1 kDa or greater, such as 1.5 kDa or greater, such as 2 kDa or greater, such as 2.5 kDa or greater, and including 3 kDa or greater. Likewise, the amount of unsaturated fatty acid in waterborne crosslinkable polymer precursors of interest may vary. For instance, polycarboxylic anhydride may be present in waterborne crosslinkable polymer precursors in an amount ranging from 1% to 50% w/w, such as 2% to 49% w/w, such as 5% to 45% w/w, such as 10% to 40% w/w, such as 15% to 35% w/w and including 20% to 30% w/w.

In some embodiments of the disclosure, the ratio of polycarboxylic acid or polycarboxylic acid anhydride to unsaturated fatty acid may vary, in some embodiments ranging between 10:1 and 9.5:1; 9.5:1 and 9:1; 9:1 and 8.5:1; 8.5:1 and 8:1; 8:1 and 7.5:1; 7.5:1 and 7:1; 7:1 and 6.5:1; 6.5:1 and 6:1; 6:1 and 5.5:1; 5.5:1 and 5:1; 5:1 and 4.5:1; 4.5:1 and 4:1; 4:1 and 3.5:1; 3.5:1 and 3:1; 3:1 and 2.5:1; 2.5:1 and 2:1; 2:1 and 1.5:1; 1.5:1 and 1:1 or a range thereof. For example, the mass ratio of the polycarboxylic acid or polycarboxylic acid anhydride to unsaturated fatty acid may range from 10:1 and 1:1, such as 8:1 and 1:1, such as 5:1 and 1:1, such as 4:1 and 1:1, and including from 2:1 and 1:1. In certain instances, the ratio of polycarboxylic acid or polycarboxylic acid anhydride to unsaturated fatty acid is 1:1.

In other embodiments, the ratio of polycarboxylic acid or polycarboxylic acid anhydride to unsaturated fatty acid may vary, in some embodiments ranging between 1:1 and 1:1.5; 1:1.5 and 1:2; 1:2 and 1:2.5; 1:2.5 and 1:3; 1:3 and 1:3.5; 1:3.5 and 1:4; 1:4 and 1:4.5; 1:4.5 and 1:5; 1:5 and 1:5.5; 1:5.5 and 1:6; 1:6 and 1:6.5; 1:6.5 and 1:7; 1:7 and 1:7.5; 1:7.5 and 1:8; 1:8 and 1:8.5; 1:8.5 and 1:9; 1:9 and 1:9.5; 1:9.5 and 1:10 or a range thereof. For example, the ratio of polycarboxylic acid or polycarboxylic acid anhydride to unsaturated fatty acid may range from 1:1 and 1:10, such as 1:1 and 1:8, such as 1:1 and 1:5, such as 1:1 and 1:4, and including from 1:1 and 1:2.

Where the subject waterborne crosslinkable polymer precursor compositions are crosslinked through one or more carbon-carbon double bonds or carbon-carbon triple bonds, the amount of unsaturated compound in the waterborne crosslinkable polymer precursor composition may vary, such as about 1 mol % or more of the unsaturated compound, such as 2 mol % or more, such as 3 mol % or more, such as 4 mol % or more and including 5 mol % or more. For example, the amount of unsaturated compound in the waterborne crosslinkable polymer precursor composition may range from 0.01 mol % to 10 mol %, such as from 0.05 mol % to 9.5 mol %, such as from 0.1 mol % to 9 mol %, such as from 0.5 mol % to 8.5 mol %, such as from 1 mol % to 8 mol %, such as from 2 mol % and 7 mol % and including from 3 mol % and 6 mol %.

In some embodiments, waterborne crosslinkable polymer precursor compositions of interest further include a crosslinkable organic medium. Crosslinkable organic media of interest may include, but is not limited to, vinyl monomers such as styrene (vinylbenzene), o-methyl styrene, abietic acid, vinyl acetate, acrylonitrile and acrylates including but not limited to acrylate, methacrylate, ethyl acrylate, butyl acrylate, butyl methacrylate, ethylene glycol diacrylate, ethylene glycol dimethacrylate, poly(ethylene glycol) diacrylate and poly(ethylene glycol) dimethacrylate, as well as analogues and derivatives thereof.

The amount of crosslinkable organic medium in compositions of interest may vary depending on the waterborne crosslinkable polymer precursors (e.g., unsaturation content, etc.) as well as the extent of crosslinking in the alkyd resin desired and may be present in an amount of 1% w/w or more, such as 2% w/w or more, such as 3% w/w or more, such as 5% w/w or more, such as 10% w/w or more, such as 15% w/w or more and including 25% w/w or more. In some instances, the amount of crosslinkable organic medium present in the subject compositions ranges from 1% to 50%, such as from 2% w/w to 45% w/w, such as from 3% w/w to 40% w/w, such as from 5% w/w to 35% w/w, such as from 10% w/w to 30% w/w and including from 15% w/w to 25% w/w.

In some embodiments, the subject compositions further include one or more radical-generating compounds, such as peroxides and the like. In certain instances, radical-generating compounds enhance drying by initiating polymerization of reactive unsaturated groups present. For example, suitable chemical initiators may include, but are not limited to, initiators which produce free radicals such as peroxides (e.g., dialkyl peroxides such as t-butyl peroxide and 2,2 bis(t-butylperoxy)propane, diacyl peroxides such as benzoyl peroxide and acetyl peroxide, peresters such as t-butyl perbenzoate and t-butyl per-2-ethylhexanoate, perdicarbonates such as dicetyl peroxy dicarbonate and dicyclohexyl peroxy dicarbonate, ketone peroxides such as cyclohexanone peroxide and methylethylketone peroxide, and hydroperoxides such as cumene hydroperoxide and tert-butyl hydroperoxide), azo compounds (e.g., azobisisobutyronitrile (AIBN) and azobis-(2,4-dimethylvaleronitrile), aliphatic azo compounds) as well as initiators which produce a positively charged species such as an acid-forming initiator like boron trifluoride, initiators which produce negatively charged species such as metal amides, alkoxides, hydroxides, cyanides, phosphines, amines, as well as organometallic compounds, like alkyllithim compounds, Ziegler catalysts or Grignard reagents. The radical-generating compound may be present in any convenient amount, and in some instances is present in an amount of 0.01 wt % or more, such as 0.05 wt % or more, such as 0.1 wt % or more, such as 0.5 wt % or more, such as 1.0 wt % or more, such as 1.5 wt % or more, such as 2 wt % or more, such as 3 wt % or more, such as 4 wt % or more and including in an amount of 5 wt % or more. For example, the amount of radical-generating compound may range from 0.01 wt % to 10 wt %, such as from 0.05 wt % to 9.5 wt %, such as from 0.1 wt % to 9 wt %, such as from 0.5 wt % to 8.5 wt %, such as from 1 wt % to 8 wt %, such as from 2 wt % to 7 wt % and including from 3 wt % to 6 wt %.

In embodiments where the subject compositions include one or more radical-generating compounds, the compositions may be configured to initiate radical generation at any suitable temperature, such as at a temperature ranging from 50° C. to 200° C., such as from 60° C. to 190° C., such as from 75° C. to 180° C., such as from 80° C. to 170° C., such as from 85° C. to 160° C., such as from 90° C. to 155° C. and including from 50° C. to 100° C., such as from 50° C. to 90° C., such as from 50° C. to 85° C., such as from 50° C. to 75 and including 50° C. to 70° C.

In certain embodiments, compositions of interest may be formulated as an ink, resin, varnish, coating, polish, thermoset resin, wood stain, floor sealant or paint. In some instances, compositions of interest having a waterborne binder, e.g., waterborne alkyd resin, and a drying agent containing a metal organic salt of an α-hydroxyacid are formulated as an ink, such as a metal plate ink, lithographic ink, relief printing ink, screen ink or offset overprinting ink. In still other instances, compositions of interest having a waterborne binder, e.g., waterborne alkyd resin, and a drying agent containing a metal organic salt of an α-hydroxyacid are formulated as a wood stain, such waterborne wood dye stains, semi-gloss stains, gloss stains, high gloss stain and satin wood stains. In certain instances, compositions of interest having a waterborne binder, e.g., waterborne alkyd resin, and a drying agent containing a metal organic salt of an α-hydroxy acid are formulated as a paint, such as eggshell paints, semi-gloss paints, flat paints, gloss paints, primer-type paints, basecoat-type paints and finish coat-type paints.

In some embodiments, compositions of interest further include one or more additional excipients, including but not limited to colorants, pigment, anti-corrosives, extenders, stabilizers, dye, surfactants, emulsifiers, anti-oxidants, plasticizers, surface-controlling agents, anti-silking agents, defoaming agents, rheological controlling agents, active metal carbonates, nitrogen-containing ligands, binders, fillers, anti-reflective agents, diluents, and toughening agents as well as ultraviolet absorbers.

In certain embodiments, compositions of interest having a waterborne binder, e.g., waterborne alkyd resin, and a drying agent containing a metal organic salt of an α-hydroxy acid further include a colorant, such as a dye or pigment. Example dye compounds of interest include, but are not limited to, a monoazo dye, a diazo dye, an azo salt, a metallic azo complex, a benzimidazole compound, a pthalocyanide, and anthraquinone, a quinacridone, a dioxazine, a perylene compound, a thioindigo, carbon black, titanium dioxide, an iron oxide, a zinc chromate, an Azurite, a chromium oxide, a calcium sulfide acridine dyes, anthraquinone dyes, arylmethane dyes, azo dyes, diazonium dies, nitro dyes, nitroso dyes, phthalocyanine dyes, quinone-imine dyes, thiazole dyes, xanthene dyes, and combinations thereof. Where the subject compositions are formulated as a paint, pigments of interest may also include metal compounds such as oxides (e.g., titanium dioxide, cobalt oxide, aluminum oxide, lead oxide, iron oxide, manganese oxide, mixtures thereof, etc.), chromates (e.g., barium chromate, strontium chromate, lead chromate, mixtures thereof, etc.), silicates (e.g., calcium copper silicate, aluminosilicates, mixtures thereof, etc.), sulfides and sulfates (e.g., cadmium sulfide, arsenic sulfide, lead sulfate, combinations thereof, etc.), nitrites (e.g., potassium cobaltinitrite, etc.), carbonates (e.g., calcium carbonate), metal complexes (e.g., copper acetate, iron hexacyanoferrate, copper carbonate, copper acetoarsenite, copper phthalocyanine, nickel azo yellow, etc.), as well as hydrates, partial hydrates, doped forms, and combinations thereof.

The amount of colorant (e.g., dye) in compositions of interest may vary, the amount of colorant ranging from 0.01% to 10% w/w, such as 0.05% to 9.5% w/w, such as 0.1% to 9%, such as 0.5% to 8.5% w/w and including 1% to 8% w/w. In other embodiments, the amount of colorant (e.g., dye) is 0.01% by weight or greater of the total weight of the subject composition, such as 0.05% by weight or greater, such as 0.1% by weight or greater, such as 0.5% by weight or greater, such as 1% by weight or greater, such as 2% by weight or greater and including 5% by weight or greater of the total weight of the composition.

In certain embodiments, compositions of interest further include an extender, such as flattening agents, de-glossing agents and the like. Extender compounds may include, but are not limited to calcium carbonate, talc, barium sulfates, kaolin, aluminum silicates, aluminum-potassium silicates, silica, mica and combinations thereof. The amount of extender in compositions of interest may vary, ranging from 0.01% to 5% w/w, such as 0.05% to 4.5% w/w, such as 0.1% to 4%, such as 0.5% to 3.5% w/w and including 1% to 3% w/w. In other embodiments, the amount of extender is 0.01% by weight or greater of the total weight of the subject composition, such as 0.05% by weight or greater, such as 0.1% by weight or greater, such as 0.5% by weight or greater, such as 1% by weight or greater, such as 1.5% by weight or greater and including 2% by weight or greater of the total weight of the composition.

In certain embodiments, compositions of interest further include an antioxidant which can which can reduce or prevent unwanted oxidation or long-term degradation of the subject compositions. Antioxidants may include, but are not limited to, ascorbyl palmitate, butylated hydroxyanisole, butylated hydroxytoluene, monothioglycerol, propyl gallate, sodium bisulfite, sodium formaldehyde sulfoxylate, sodium metabisulfite, and any combinations thereof as well as antioxidants such as those sold by Mayzo, Inc. (Suwanee, Ga.), including phosphites (Benefos®) organic compounds (BNX® products, BLS® products). The amount of antioxidant in compositions of interest may vary, ranging from 0.01% to 5% w/w, such as 0.05% to 4.5% w/w, such as 0.1% to 4%, such as 0.5% to 3.5% w/w and including 1% to 3% w/w. In other embodiments, the amount of extender is 0.01% by weight or greater of the total weight of the subject composition, such as 0.05% by weight or greater, such as 0.1% by weight or greater, such as 0.5% by weight or greater, such as 1% by weight or greater, such as 1.5% by weight or greater and including 2% by weight or greater of the total weight of the composition.

In some embodiments, compositions of interest further a surfactant. Surfactants of interest include, but are not limited to, polysorbates, such as “Tween 20” and “Tween 80,” and pluronics such as F68 and F88 (BASF, Mount Olive, N.J.; sorbitan esters; lipids, such as phospholipids such as lecithin and other phosphatidylcholines, phosphatidylethanolamines (although preferably not in liposomal form), fatty acids and fatty esters; steroids, such as cholesterol; chelating agents, such as EDTA and any combination thereof. The amount of surfactant in compositions of interest may vary, ranging from 0.01% to 5% w/w, such as 0.05% to 4.5% w/w, such as 0.1% to 4%, such as 0.5% to 3.5% w/w and including 1% to 3% w/w. In other embodiments, the amount of surfactant is 0.01% by weight or greater of the total weight of the subject composition, such as 0.05% by weight or greater, such as 0.1% by weight or greater, such as 0.5% by weight or greater, such as 1% by weight or greater, such as 1.5% by weight or greater and including 2% by weight or greater of the total weight of the composition.

In certain instances, the subject compositions include a biocide or anti-microbial agent so as to prevent or deter microbial growth, such as for example benzalkonium chloride, benzethonium chloride, benzyl alcohol, cetylpyridinium chloride, chlorobutanol, phenol, phenylethyl alcohol, thimersol, and any combinations thereof. The amount of surfactant in compositions of interest may vary, ranging from 0.001% to 2% w/w, such as 0.005% to 1.75% w/w, such as 0.01% to 1.5%, such as 0.05% to 1.25% w/w and including 0.1% to 1% w/w. In other embodiments, the amount of biocide or anti-microbial agent is 0.001% by weight or greater of the total weight of the subject composition, such as 0.005% by weight or greater, such as 0.01% by weight or greater, such as 0.05% by weight or greater, such as 0.1% by weight or greater, such as 0.5% by weight or greater and including 1% by weight or greater of the total weight of the composition.

In some embodiments, compositions of interest further include a dispersant or emulsifier. In these embodiments, the dispersant may also function as a stabilizer. Examples of dispersants and emulsifiers include, but are not limited to, sodium lauryl sulfate, sodium dodecyl benzene sulfonate, dioctylsulfosuccinate, sodium polyoxyethylene lauryl ether sulfate, sodium dodecyl diphenyloxide disulfonate and other diphenylsulfonate derivatives and combinations thereof as well as surfactants manufactured by Rohm & Haas under the trademark OROTAN® (e.g., 1124, 1288, 731 DP and 850). The amount of dispersant or emulsifier in compositions of interest may vary, ranging from 0.01% to 5% w/w, such as 0.05% to 4.5% w/w, such as 0.1% to 4%, such as 0.5% to 3.5% w/w and including 1% to 3% w/w. In other embodiments, the amount of dispersant or emulsifier is 0.01% by weight or greater of the total weight of the subject composition, such as 0.05% by weight or greater, such as 0.1% by weight or greater, such as 0.5% by weight or greater, such as 1% by weight or greater, such as 1.5% by weight or greater and including 2% by weight or greater of the total weight of the composition.

### Methods for Forming a Coating on a Surface of a Support

Aspects of the disclosure also include methods for forming a coating on a surface of a support. Methods according to certain embodiments include applying to the surface of the support a composition having a waterborne (e.g., waterborne alkyd resin, waterborne urethane resin, such as a waterborne oil-modified urethane resin, etc.) or oil-based composition (e.g. oil-based alkyd resin, oil-based urethane resin, etc.) and a drying agent that includes a metal organic salt of an α-hydroxy acid. By “applying” is meant contacting one or more of the subject compositions onto a surface, such as for example, onto the surface of a support. As such, applying may include depositing or otherwise positioning one or more of the subject compositions on a surface. In certain embodiments, applying includes depositing a thin layer of the subject compositions onto a surface, such as layer having a thickness of 1 nm or more, such as 2 nm or more, such as 5 nm or more, such as 10 nm or more, such as 25 nm or more, such as 50 nm or more and including 100 nm or more. In embodiments, the subject composition may be applied over the entire support surface or a part of the support surface, as desired. In some embodiments, applying includes depositing the subjection composition onto less than the entire surface of the support. For instance, applying may include depositing onto 50% or less of the entire surface of the support, such as 45% or less, such as 40% or less, such as 35% or less, such as 30% or less and including 25% or less of the entire surface of the support. In certain instances, applying includes depositing the subject composition to specific locations on the support surface. For example, depositing to specific locations may include depositing onto the support surface in the form of spots (or any other geometric shape) or strips (e.g., straight or non-straight having regular and irregular patterns).

In embodiments, supports of interest may be flat, curved, smooth, rough, porous, non-porous, or any combination thereof. In some instances, supports include, but are not limited to, wood (e.g., floors, walls, carvings, etc.), synthetic polymers (e.g., plastic sheeting, wall covers, containers, etc.), metals (e.g., automobile body panels, boat hulls, etc.), fabric (e.g., canvas, denim, etc.), ceramic (e.g., pottery, fiberglass, etc.), composites (e.g., reinforced carbon fibers, etc.) as well as combinations thereof.

The thickness of the layer of composition applied to the surface of the support will depend on the desired properties, the rate of application, the number of layers applied and the duration of application. One or more layers of the subject compositions may be applied to the support surface. For example, two or more layers may be applied to the support surface, such as three or more layers, such as four or more layers, including 5 or more layers of the subject composition may be applied to the support surface. As described in greater detail below, additional layers of the subject compositions may be added if necessary, such as for example to improve smoothness and uniformity of the completed surface coating. For example, if after evaluating the deposited coating composition (by methods as described below), it is determined that the composition applied to the surface of the support is less than optimal or is unsuitable, additional coating layers may be applied to all or part of the deposited coating.

The thickness of the composition applied to the surface of the support may vary, such as 0.1 μm or more, such as 0.5 μm or more, such as 1.0 μm or more, such as 1.5 μm or more, such as 2.0 μm or more, such as μm or more, such as 10 μm or more, including 100 μm or more. For example, the composition applied to the surface of the support may have a thickness which ranges from 0.1 μm to 250 μm, such as from 0.5 μm to 200 μm, such as from 1 μm to 150 μm, such as from 5 μm to 100 μm, such as from 10 μm to 90 μm and including from 25 μm to 75 μm. In certain embodiments, the composition applied to the surface of the support has a thickness of 50 μm.

The subject compositions may be applied by any convenient protocol, such as for example by brushing, rolling, spraying, spin coating, dip coating, mist coating, among other protocols. Depending on the protocol used to apply the subject composition to the support surface, each coating layer may be applied over a duration of 0.5 hours or longer, such as 1 hour or longer, such as 2 hours or longer, such as 5 hours or longer, such as 10 hours or longer, such as 30 hours or longer, including 60 hours or longer. For example, each coating layer may be applied over the course of from 0.1 hours to 100 hours, such as from 0.5 hours to 96 hours, such as from 0.1 hours to 84 hours, such as from 0.5 hours to 72 hours, such as from 1 hour to 60 hours, such as from 2 hours to 48 hours, such as from 3 hours to 36 hours and including over the course of from 6 hours to 24 hours.

Compositions of interest may be applied to form a coating on a support surface at temperatures which vary, depending on the proportion of water binder, e.g., waterborne alkyd resin, as well as other additives, when present as described above. In embodiments, methods include applying to the surface of the support a composition having a waterborne binder, e.g., waterborne alkyd resin, and a drying agent that includes a metal organic salt of an α-hydroxy acid at a temperature ranging such as from −50° C. to 250° C., such as from −25° C. to 200° C., such as from 0° C. to 150° C., such as from 10° C. to 100° C. and including from 15° C. to 85° C. In certain embodiments, the subject compositions are applied to a surface at ambient room temperature. If desired, the temperature may be modified at any time. In some instances, the temperature is not changed and remains the same throughout the entire time the composition is applied to the support surface. In other embodiments, the temperature may be increased or decreased. For example, the temperature may be increased or decreased by 0.01° C. or more, such as 0.05° C. or more, such as 0.1° C. or more, such as 0.5° C. or more, such as 1° C. or more, such as 5° C. or more, such as 10° C. or more, such as 15° C. or more, such as 20° C. or more, such as 25° C. or more, including by 50° C. or more.

After compositions are applied to the support, methods may also include subjecting the applied coating to conditions sufficient to dry the coating on the substrate. In some embodiments, drying the composition applied to the surface of the support includes subjecting the composition to conditions sufficient to crosslink a crosslinkable polymer precursor in the composition. As discussed above, any desired amount of the crosslinkable polymer precursor may be crosslinked to dry the coating on the support, such as crosslinking 5% or more of the crosslinkable polymer precursor, such as 10% or more, such as 25% or more, such as 50% or more, such as 75% or more, such as 90% or more, such as 95% or more and including crosslinking 99% or more of the crosslinkable polymer precursor in the composition.

The amount of time required to dry (e.g., crosslink a waterborne crosslinkable polymer precursor in a waterborne alkyd resin) the applied coating may vary depending on the amount of drying agent present and other additives present, as discussed above. In embodiments, the composition applied to the surface of the support forms a dry coating on the support in 72 hours or less, such as 60 hours or less, such as 48 hours or less, such as 36 hours or less, such as 24 hours or less, such as 18 hours or less, such as 12 hours or less, such as 6 hours or less and including drying in 3 hours or less. For example, the composition applied to the surface of the support may form a dry coating on the support in a duration which ranges from 1 hour to 72 hours, such as from 2 hours to 60 hours, such as from 3 hours to 48 hours, such as from 6 hours to 36 hours, such as from 12 hours to 30 hours and including from 18 hours and 24 hours. In certain embodiments, the composition applied to the surface of the support forms a dry coating on the support in 24 hours or less.

In certain embodiments, the composition applied to the surface of the support is subjected to conditions sufficient to produce a hard coating on the surface of the support. By “hard” is meant that the coating has a solid consistency where the coating formed on the support surface may be flexible, pliable or rigid. The term “flexible” is used in its conventional sense to mean that the coating is capable of being bent without breaking or otherwise able to be turned, bowed, or twisted, without breaking. In these embodiments, the coating may be pliable and is not rigid or stiff. In other embodiments, the coating formed on the support surface is rigid. The term “rigid” is used in its conventional sense to mean that the coating is stiff and not capable of substantially being bent without cracking or breaking.

In some embodiments, the composition applied to the surface of the support is subjected to conditions sufficient to produce a coating on the surface of the support having a durometer hardness which ranges from 10 Shore OO to 100 Shore OO, such as 20 Shore OO to 90 Shore OO, such as 30 Shore OO to 80 Shore OO and including 40 Shore OO to 70 Shore OO. In other embodiments, the composition applied to the surface of the support is subjected to conditions sufficient to produce a coating on the surface of the support having a durometer hardness which ranges from 10 Shore A to 100 Shore A, such as 20 Shore A to 90 Shore A, such as 30 Shore A to 80 Shore A and including 40 Shore A to 70 Shore A.

In some instances, drying the composition applied to the surface of the support includes air-drying. The term “air-drying” is used herein in its conventional sense to refer to contacting the subject compositions with a gaseous composition, such as atmospheric air, to dry the composition. Air-drying, according to certain embodiments, includes exposing the composition to a gaseous composition having one or more gaseous components, such as two or more gaseous components, such as three or more, such as four or more, such as five or more and including ten or more gaseous components. For example, air-drying may include contacting the composition applied to the surface of the support with a gaseous composition containing one or more of oxygen, nitrogen, helium, hydrogen, argon, xenon, carbon dioxide, carbon monoxide, among other gases. In some embodiments, air-drying includes contacting with oxygen gas. In other embodiments, air-drying includes contacting with atmospheric air.

Air-drying may also include contacting the composition applied to the surface of the support with a gaseous composition under modified pressure conditions. For example, in some instances the composition applied to the surface of the support is contacted with the gaseous composition under increased pressure relative to atmospheric pressure, such as under a pressure of 0.001 kPa or more above atmospheric pressure, such as 0.005 kPa or more, such as 0.01 kPa or more, such as 0.05 kPa or more, such as 0.1 kPa or more, such as 0.5 kPa or more, such as 1 kPa or more, such as 2.5 kPa or more, such as 5 kPa or more, such as 10 kPa or more and including under a pressure of 25 kPa or more above atmospheric pressure. In other instances, the composition applied to the surface of the support is contacted with the gaseous composition under reduced pressure relative to atmospheric pressure, such as under a pressure of 0.001 kPa or below atmospheric pressure, such as 0.005 kPa or more, such as 0.01 kPa or more, such as 0.05 kPa or more, such as 0.1 kPa or more, such as 0.5 kPa or more, such as 1 kPa or more, such as 2.5 kPa or more, such as 5 kPa or more, such as 10 kPa or more and including under a pressure of 25 kPa or more below atmospheric pressure.

Air-drying may also include contacting the composition applied to the surface of the support with a gaseous composition under modified temperature. For example, in some instances the composition applied to the surface of the support is contacted with the gaseous composition under an elevated temperature relative to room temperature, such as under a temperature of 1° C. or more above room temperature, such as 2° C. or more, such as 5° C. or more, such as 10° C. or more, such as 15° C. or more, such as 20° C. or more, such as 25° C. or more, such as 30° C. or more, such as 35° C. or more, such as 40° C. or more and including under an elevated temperature of 50° C. or more above room temperature. In other instances, the composition applied to the surface of the support is contacted with the gaseous composition under a reduced temperature relative to room temperature, such as under a temperature of 1° C. or more below room temperature, such as 2° C. or more, such as 5° C. or more, such as 10° C. or more, such as 15° C. or more, such as 20° C. or more, such as 25° C. or more, such as 30° C. or more, such as 35° C. or more, such as 40° C. or more and including under a reduced temperature of 50° C. or more below room temperature.

In certain instances, methods include conditioning the surface of the support prior to applying the subject composition, i.e., the support surface is conditioned prior to application. By “conditioned” is meant that the support is prepared for deposition of the coating composition. In certain instances, the support is subjected to a process which prepares the support to be more receptive to the applied composition of interest. By “more receptive” is meant that conditioning process improves the deposition (e.g. adhesion, surface smoothness, etc.) of the subject composition to the support surface. In one example, the conditioning process increases the surface area of the support, such as by roughening the support by sanding the surface. For instance, roughening the surface may increase the surface area of the support by 5% or more, such as by 10% or more, such as by 15% or more, such as by 25% or more, such as by 35% or more, such as by 40% or more and including increasing the surface area of the support by 50% or more. In another example, the conditioning process increases the hydrophilicity of the support surface. For example, the conditioning process increases the hydrophilicity of the support surface by 2 times or more, such as 3 times or more, such as 5 times or more, including 10 times or more. The hydrophilicity of the support surface may be measured by any convenient protocol, such as for example measuring surface contact angles, flow microcalorimetry and the like. In other instances, the conditioning process increases the adhesion of the subject compositions to the support surface. For example, the conditioning process increases the adhesion of the subject composition to the support surface by 2 times or more, such as 3 times or more, such as 5 times or more, including 10 times or more.

In some embodiments, more than one layer of the subject composition is applied to the support. For example, two or more coating layers of the subject composition may be applied, such as three or more coating layers and including five or more coating layers. In some embodiments, each subsequent coating layer is applied after a predetermined period after deposition of the previous coating layer. For example, each subsequent layer may be applied, 1 hour or more after the previous coating layer is applied, such as 2 hours or more, such as 5 hours or more, such as 10 hours or more, such as 60 hours or more and including 96 hours or more after the previous layer is deposited.

In certain embodiments, a subsequent coating layer is applied on top of the previous coating layer immediately after applying the coating layer to the support. By “immediately” is meant that the subsequent coating layer is applied as soon as deposition of the previous coating layer is complete. In some instances, application of a subsequent coating layer may even commence for a short predetermined period of time prior to completion of deposition of the previous coating layer resulting in a multicomponent layer (composed of both the first coating layer material and second coating layer material) formed between the first coating layer and second coating layer.

Methods for forming a coating on a surface of a support may also include monitoring the composition applied to the surface of the support. By “monitoring” is meant that one or more properties of the coating layers are determined and assessed in conjunction with or after application. In some embodiments, methods include determining the physical makeup of the composition applied to the surface of the support. Determining the physical makeup refers to the analysis of one or more physical parameters of the composition applied to the surface of the support. For example, the amount of material deposited, thickness, smoothness, uniformity of each layer and wettability may be assessed. Any convenient protocol can be employed to determine the physical makeup of the composition applied to the surface of the support. Methods for analyzing the physical makeup of the composition applied to the surface of the support include, but are not limited to quartz crystal microbalance, visible microscopy, electron microscopy, surface reflection analysis, contact angle studies, among others. In other embodiments, methods include determining the chemical makeup of the composition applied to the surface of the support. Determining the chemical makeup refers to the analysis of one or more of the chemical properties the composition applied to the surface of the support, such as for example monitoring the extent of crosslinking of the applied composition. Determining the makeup of the composition applied to the surface of the support may also include, but is not limited to determining the metal composition, amount of impurities as well as spectroscopic properties. Any convenient protocol can be employed to determine the makeup of the composition applied to the surface of the support. Methods for analyzing the makeup of the composition applied to the surface of the support include, but are not limited to IR spectroscopy, UV-vis spectrophotometry, visible microscopy, as well as electron microscopy.

The composition applied to the surface of the support may be monitored at any phase during the subject methods. For example, the makeup of the composition applied to the surface of the support may be determined immediately after application. In other embodiments, the makeup of the composition applied to the surface of the support is determined throughout the application process. For instance, data (i.e., thickness, conductivity, impurity content, etc.) about the composition applied to the surface of the support may be monitored throughout the deposition process, such by real-time data collection. In other embodiments, the composition applied to the surface of the support may be monitored during the application process by collecting data at regular intervals, e.g., collecting data every 1 minute, every 5 minutes, every 10 minutes, every 30 minutes, every 60 minutes, every 100 minutes, every 200 minutes, every 500 minutes, or some other interval.

Methods of the present disclosure also include assessing the collected data. By “assessing” the collected data is meant that a human (either alone or with the assistance of a computer, if using a computer automated process initially set up under human direction), evaluates the collected data about the composition applied to the surface of the support and determines whether the each layer is suitable or unsuitable. For example, if after assessing that the composition applied to the surface of the support is suitable, no further adjustments may be made. In other words, methods of these embodiments include a step of assessing the collected data to identify any desired adjustments to the composition applied to the surface of the support. The desired adjustments may vary in terms of goal, where in some instances the desired adjustments that ultimately result in enhanced efficiency of some desirable parameter, e.g., smoothness, uniformity and thickness. In some instances, where the composition applied to the surface of the support has been determined to be at least less than optimal, that coating may be further processed. If necessary, the composition applied to the surface of the support may be further processed at more than one times during methods of the present disclosure, such as two or more times, such as three or more times, such as four or more times and including five or more times.

In certain embodiments, processing may include adjusting the thickness of the composition applied to the surface of the support. For instance, processing the composition applied to the surface of the support may include increasing the thickness of the applied coating layer, such as by 0.1 nm or more, such as 0.5 nm or more, such as 1.0 nm or more, such as 1.5 nm or more, such as 2.0 nm or more, such as 5 nm or more, including 10 nm or more. The thickness of part or all of each coating layer maybe adjusted. For example, in some embodiments, methods include increasing the thickness of the entire applied coating layer. In other embodiments, less than that entire applied coating layer may be increased in thickness, such as 95% or less of the deposited layer is increased in thickness, such as 75% or less, such as 50% or less, such as 25% or less, such as 10% or less, and including 5% or less of the composition applied to the surface of the support is increased in overall thickness. In certain instances, specific regions on the composition applied to the surface of the support may be adjusted, resulting in discrete portions of the applied coating layer having varying thickness.

In other embodiments, processing may include adjusting the smoothness of the composition applied to the surface of the support. For instance, processing may include improving the smoothness of the composition applied to the surface of the support. All or a portion of the applied coating layer may be processed to improve the smoothness of the composition applied to the surface of the support. For example, in some embodiments, methods include improving the smoothness of the entire applied coating layer. In other embodiments, less than that entire applied coating layer may be process to improve smoothness, such as 95% or less, such as 75% or less, such as 50% or less, such as 25% or less, such as 10% or less, and including 5% or less of the composition applied to the surface of the support is processed to improve smoothness. In some instances, specific positions on the applied coating layer may be targeted for improving smoothness.

### Methods for Preparing an Air-Drying Composition

As summarized above, aspects of the disclosure also include methods for preparing the subject compositions. In some embodiments, methods for preparing the subject compositions include combining a waterborne composition, such as a waterborne alkyd resin or an oil-modified urethane and a drying agent having a metal organic salt of an α-hydroxy acid. Where the drying agent is incorporated into a waterborne binder, e.g., waterborne alkyd resin, the drying agent may be incorporated into the waterborne binder, e.g., waterborne alkyd resin, directly. In other embodiments, the drying agent is first mixed with water or a water-miscible solvent and subsequently incorporated into the waterborne binder, e.g., waterborne alkyd resin. In yet other embodiments, the drying agent is prepared as a suspension or emulsion in water and subsequently incorporated into the waterborne binder, e.g., waterborne alkyd resin. As discussed above, the drying agent is capable of being stably incorporated into waterborne compositions, such in the absence of surfactant.

In some embodiments, the drying agent is mixed with water or a water-miscible solvent and subsequently incorporated into the waterborne binder, e.g., waterborne alkyd resin. In certain instances, the drying agent is mixed with two or more water-miscible solvents, such as three or more, such as four or more and including five or more water-miscible. Water miscible solvents of interest may include, but are not limited to, glycols, glycol ethers, acetaldehyde, acetic acid, acetone, acetonitrile, 1,2-butanediol, 1,3-butanediol, 1,4-butanediol, 2-butoxyethanol, butyric acid, diethanolamine, diethylenetriamine, dimethylformamide, dimethoxyethane, dimethyl sulfoxide, 1,4-dioxane, ethanol, ethylamine, ethylene glycol, formic acid, furfuryl alcohol, glycerol, methanol, methyl diethanolamine, methyl isocyanide, 1-propanol, 1,3-propanediol, 1,5-pentanediol, 2-propanol, propanoic acid, propylene glycol, pyridine, tetrahydrofuran, triethylene glycol.

Where the drying agent is first mixed with water or a water-miscible solvent before incorporating into the waterborne binder, e.g., waterborne alkyd resin, the amount of drying agent in the solvent mixture may vary, ranging in some instances from 0.001% to 5% w/w, such as from 0.005% to 4.5% w/w, such as from 0.01% to 4% w/w, such as from 0.05% to 3.5% w/w, such as from 0.1% to 3.0% w/w, such as from 0.5% to 2.5% and including from 1% to 2% w/w. In some embodiments, the drying agent is present in the solvent mixture in an amount of 5% w/w or less, such as 4.5% w/w or less, such as 4% w/w or less, such as 3.5% w/w or less, such as 3% w/w or less, such as 2.5% w/w or less, such as 2% w/w or less, such as 1.5% w/w or less, such as 1% w/w or less, such as 0.5% w/w or less and including 0.1% w/w or less.

The amount of drying agent combined with the waterborne (e.g., waterborne alkyd resin, waterborne urethane resin, such as a waterborne oil-modified urethane resin, etc.) or oil-based (e.g., oil-based alkyd resin, oil-based urethane resin, etc.) composition may vary, such as 0.0001 wt % or greater, such as 0.001 wt % or greater, such as 0.001 wt % or greater, such as 0.01 wt % or greater, such as 0.1 wt % or greater, such as 1 wt % or greater, such as 1.5 wt % or greater, such as 2 wt % or greater, such as 2.5 wt % or greater, such as 3 wt % or greater, such as 3.5 wt % or greater, such as 4 wt % or greater, such as 4.5 wt % or greater and including in an amount of about 5 wt % or greater. In some embodiments, the amount of α-hydroxy acid metal salt in the subject compositions ranges from 0.0001% to 5% w/w, such as from 0.005% to 4.5% w/w, such as from 0.01% to 4%, such as from 0.05% to 3.5% w/w and including 0.1% to 3% w/w.

The drying agent having a metal organic salt of an α-hydroxy acid may be mixed with the waterborne (e.g., waterborne alkyd resin, waterborne urethane resin, such as a waterborne oil-modified urethane resin, etc.) or oil-based (e.g., oil-based alkyd resin, oil-based urethane resin, etc.) composition by any convenient mixing protocol so long as the drying agent and waterborne or oil-based composition are sufficiently incorporated together, such as but not limited to planetary mixers, Patterson-Kelley blender, hand mixers, standup mixers, inline mixers, powder liquid mixers, batch mixers, kneaders, agitator drives, impellers, hydrofoil mixers, aerators, among other mixing protocols. For example, the drying agent and waterborne or oil-based composition may be mixed for 1 minute or more, such as for 2 minutes or more, such as for 5 minutes or more, such as for 10 minutes or more, such as for 30 minutes or more, such as for 60 minutes or more and including mixing for such as from 120 minutes or more. The drying agent and waterborne or oil-based composition may be at any suitable temperature when combined together, so long as the temperature does not degrade or negatively affect the subject compositions. In embodiments, the drying agent and waterborne or oil-based composition may be at a temperature ranging from −50° C. to 250° C., such as from −25° C. to 200° C., such as from 0° C. to 150° C., such as from 10° C. to 100° C. and including from 15° C. to 85° C. If desired, the temperature may be modified at any time. In some instances, the temperature is not changed. In other embodiments, the temperature may be increased or decreased. For example, the temperature may be increased or decreased by 0.01° C. or more, such as 0.05° C. or more, such as 0.1° C. or more, such as 0.5° C. or more, such as 1° C. or more, such as 5° C. or more, such as 10° C. or more, such as 15° C. or more, such as 20° C. or more, such as 25° C. or more, including by 50° C. or more.

As discussed above, the subject compositions further include one or more additional excipients, including but not limited to, colorants, pigment, anti-corrosives, extenders, stabilizers, dye, surfactants, emulsifiers, anti-oxidants, plasticizers, surface-controlling agents, anti-silking agents, defoaming agents, rheological controlling agents, active metal carbonates, nitrogen-containing ligands, binders, fillers, anti-reflective agents, diluents, and toughening agents as well as ultraviolet absorbers.

In some embodiments, all of the components are added to the mixer simultaneously. In other embodiments, each component may be added to the mixer sequentially. One or more components may be mixed concurrently while being added to the mixer or all of the components are first added to the mixer and then the entire composition of interest (e.g., paint, varnish, wood stain) is mixed.

### Kits

Also provided are kits, where kits at least include one or more, e.g., a plurality of the subject drying agents, as described above. In certain embodiments, the subject drying agents in the kits may be provided in a package. For example, the compositions of the kits may be presented in individual pouches, bottles, or analogous containers, to preserve the compositions until use. For example, one form of suitable packaging is an air-tight container, air-tight bag, re-sealable water-tight/air-tight container, water-impermeable plastics material (e.g., polyvinylchloride), etc.

In addition, kits may also include instructions for preparing the subject compositions such as where the instructions may include information about to how to combine the drying agent with a liquid composition (e.g., waterborne alkyd resin, oil-modified urethane, etc.). The instructions are recorded on a suitable recording medium. For example, the instructions may be printed on a substrate, such as paper or plastic, etc. As such, the instructions may be present in the kits as a package insert, in the labeling of the container of the kit or components thereof (i.e. associated with the packaging or sub-packaging) etc. In other embodiments, the instructions are present as an electronic storage data file present on a suitable computer readable storage medium, e.g., portable flash drive, CD-ROM, diskette, etc. In yet other embodiments, the actual instructions are not present in the kit, but means for obtaining the instructions from a remote source, e.g. via the internet, are provided. An example of this embodiment is a kit that includes a web address where the instructions can be viewed and/or from which the instructions can be downloaded. As with the instructions, the protocol for obtaining the instructions may be recorded on a suitable substrate.

### Utility

The subject drying agents, compositions, methods and kits of the present disclosure find use in a variety of different applications where it is desirable to dry a composition, such as to obtain a coating having improved properties (e.g., smoothness, homogeneity and hardness) of paints, stains, varnishes, polishes or other types of surface coatings. The present disclosure also finds use in applications where it is desirable to reduce environmental concerns pertaining to the use of oil-based paints and resins due to volatile organic compounds, water polluting solvent bases that are often poured down residential drains and in landfill designated trash.

In some embodiments, the subject drying agents and compositions may facilitate preparation of coating compositions which are environmentally friendly, containing mostly waterborne and biodegradable components. In some embodiments, the subject compositions are less carcinogenic, toxic (to animals, plants, the environment, etc.) and environmentally invasive as compared with traditional coating compositions.

Although the foregoing disclosure has been described in some detail by way of illustration and example for purposes of clarity of understanding, it is readily apparent to those of ordinary skill in the art in light of the teachings of this disclosure that certain changes and modifications may be made thereto without departing from the spirit or scope of the appended claims.

Accordingly, the preceding merely illustrates the principles of the disclosure. It will be appreciated that those skilled in the art will be able to devise various arrangements which, although not explicitly described or shown herein, embody the principles of the disclosure and are included within its spirit and scope. Furthermore, all examples and conditional language recited herein are principally intended to aid the reader in understanding the principles of the disclosure and the concepts contributed by the inventors to furthering the art, and are to be construed as being without limitation to such specifically recited examples and conditions. Moreover, all statements herein reciting principles, aspects, and embodiments of the disclosure as well as specific examples thereof, are intended to encompass both structural and functional equivalents thereof. Additionally, it is intended that such equivalents include both currently known equivalents and equivalents developed in the future, i.e., any elements developed that perform the same function, regardless of structure. The scope of the present disclosure, therefore, is not intended to be limited to the exemplary embodiments shown and described herein. Rather, the scope and spirit of present disclosure is embodied by the appended claims.

1. A drying agent for drying a liquid composition comprising a metal organic salt of an α-hydroxy acid.

2. The drying agent according to claim 1, wherein the α-hydroxy acid is a compound selected from the group consisting of glycolic acid, lactic acid, tartaric acid, citric acid, malic acid and mandelic acid and combinations thereof.

3-4. (canceled)

5. The drying agent according to claim 1, wherein the drying agent comprises a cobalt or manganese salt of glycolic acid or lactic acid.

6. The drying agent according to claim 5, wherein the drying agent comprises a cobalt salt of glycolic acid.

7. The drying agent according to claim 5, wherein the drying agent comprises a manganese salt of glycolic acid.

8. The drying agent according to claim 5, wherein the drying agent comprises a cobalt salt of lactic acid.

9. The drying agent according to claim 5, wherein the drying agent comprises a manganese salt of lactic acid.

10. The drying agent according to claim 1, wherein the metal organic salt of an α-hydroxy acid is capable of being stably incorporated into a waterborne composition in the absence of a surfactant.

11. The drying agent according to claim 1, wherein the metal organic salt of an α-hydroxy acid is capable of stably being incorporated into an oil based composition.

12. The drying agent according to claim 11, wherein the oil based composition is an oil-based urethane.

13. A composition comprising:
a waterborne or oil-based composition; and
a drying agent comprising a metal organic salt of an α-hydroxy acid.

14. The composition according to claim 13, wherein the waterborne composition is a waterborne alkyd resin.

15. The composition according to claim 14, wherein the drying agent is homogeneously incorporated into the waterborne alkyd resin in the absence of a surfactant.

16. The composition according to claim 13, wherein the oil-based composition is an oil-based urethane resin.

17. The composition according to claim 13, wherein the α-hydroxy acid is a compound selected from the group consisting of glycolic acid, lactic acid, tartaric acid, citric acid, malic acid and mandelic acid and combinations thereof.

18-19. (canceled)

20. The composition according to claim 13, wherein the drying agent comprises a cobalt or manganese salt of glycolic acid or lactic acid.

21. The composition according to claim 20, wherein the drying agent comprises a cobalt salt of glycolic acid.

22. The composition according to claim 20, wherein the drying agent comprises a manganese salt of glycolic acid.

23. The composition according to claim 20, wherein the drying agent comprises a cobalt salt of lactic acid.

24. The composition according to claim 20, wherein the drying agent comprises a manganese salt of lactic acid.

25-49. (canceled)

50. A method for forming a coating on a surface, the method comprising applying to the surface a composition comprising a waterborne or oil-based composition and a drying agent comprising a metal organic salt of an α-hydroxy acid.

51-115. (canceled)
